SEQUENCE LISTING (16 sequences)

SEQ ID NO: 1 - protein, 657 aa, E. coli
MTQLAIGKPAPLGAHYDGQGVNFTLFSAHAERVELCVFDANGQEHRYDLPGHSGDIWHGYLPDARPGLRYGYRVHGPWQPAEGHRFNPAKLLIDPCARQIDGEFKDNPLLHAGHNEPDYRDNAAIAPKCVVVVDHYDWEDDAPPRTPWGSTIIYEAHVKGLTYLHPEIPVEIRGTYKALGHPVMINYLKQLGITALELLPVAQFASEPRLQRMGLSNYWGYNPVAMFALHPAYACSPETALDEFRDAIKALHKAGIEVILDIVLNHSAELDLDGPLFSLRGIDNRSYYWIREDGDYHNWTGCGNTLNLSHPAVVDYASACLRYWVETCHVDGFRFDLAAVMGRTPEFRQDAPLFTAIQNCPVLSQVKLIAEPWDIAPGGYQVGNFPPLFAEWNDHFRDAARRFWLHYDLPLGAFAGRFAASSDVFKRNGRLPSAAINLVTAHDGFTLRDCVCFNHKHNEANGEENRDGTNNNYSNNHGKEGLGGSLDLVERRRDSIHALLTTLLLSQGTPMLLAGDEHGHSQHGNNNAYCQDNQLTWLDWSQASSGLTAFTAALIHLRKRIPALVENRWWEEGDGNVRWLNRYAQPLSTDEWQNGPKQLQILLSDRFLIAINATLEVTEIVLPAGEWHAIPPFAGEDNPVITAVWQGPAHGLCVFQR

SEQ ID NO: 2 - protein, 485 aa, Bacillus sp.
HHNGTNGTMMQYFEWHLPNDGNHWNRLRDDASNLRNRGITAIWIPPAWKGTSQNDVGYGAYDLYDLGEFNQKGTVRTKYGTRSQLESAIHALKNNGVQVYGDVVMNHKGGADATENVLAVEVNPNNRNQEISGDYTIEAWTKFDFPGRGNTYSDFKWRWYHFDGVDWDQSRQFQNRIYKFRGDGKAWDWEVDSENGNYDYLMYADVDMDHPEVVNELRRWGEWYTNTLNLDGFRIDAVKHIKYSFTRDWLTHVRNATGKEMFAVAEFWKNDLGALENYLNKTNWNHSVFDVPLHYNLYNASNSGGNYDMAKLLNGTVVQKHPMHAVTFVDNHDSQPGESLESFVQEWFKPLAYALILTREQGYPSVFYGDYYGIPTHSVPAMKAKIDPILEARQNFAYGTQHDYFDHHNIIGWTREGNTTHPNSGLATIMSDGPGGEKWMYVGQNKAGQVWHDITGNKPGTVTINADGWANFSVNGGSVSIWVKR

SEQ ID NO: 3 - protein, 464 aa, Streptomyces avermitilis
DATIAVNPSTTYGKWEGWGTSLAWWANVFGARDDFADLFFTTKSVTYNGRTLPGLGLNIARYNLGACSWNSVSGESMVASANIPAFKQIEGYWQDWNNEDPTSSAWKWTADAAQRTMLVKATARGATTELFANSPMWWMCLNHNPSGASGGGNNLQSWNYRQHASHLAAVALYAKSNWGVNFATVDPFNEPSSSWWTATGTQEGCHMDASVQAAVLPYLRSELDRRGLTGTKISASDETSYDLARTTWGSFGSSTKALVNRVNVHGYQGSGGRRDLLYTDVVTTAGKALWNSETGDSDGTGLTLASNLCLDFRWLHPTAWVYWQVMDPSSGWAMIAYDASTLQPGAVQTKYYVMAQFSRHIRAGMTIVDTGVGYAAAAYDATARRLVIVAVNTSTSAQTLTFDLSRFSTVTGGTGGLVRRWNTVTGGGGDLYAAHSDTYLSGKSLSVPFAAGAVQTLEVDGVTV

SEQ ID NO: 4 - protein, 458 aa, Trichoderma harzianum
DTTLSIDPTSNWGTWEGWGVSLAWWAKAFGNRDDLANVFFTRNNQVINGQNLPGLGFNIARYNAGACSTNTYNGSSMVVSSSIKPSRQVDGYWLDWASTDPASSSWNWNVDANQRAMLQKAKANGANIFELFSNSPMWWMCLNHNPSGSGSSDNLQSWNYQNHAVYLANIAQHAQQNWGIQFQSVEAFNEPSSGWGPTGTQEGCHFAVSTMATVIGYLNTELAQRGLSSFISASDETSYDLAISTWQGLGSSAQNAVKRVNVHGYQGGGGRRDTLYSLVSQAGKRLWNSEYGDADASGKSMYTNLLLDFTWLHPTAWVYWQAIDGSGWGLIVGDNDQLTLSSASTKYFVLAQLTRHIRPGMQILTTPDGNTVAAYDSGSQKLVIVAANWGSAQTITFDLTRAKTAGSNGATVPRWSTQTSGGDQYKSYSDTKINNGKFSVSFSTGQVQTFEISGVVLK

SEQ ID NO: 5 - protein, 109 aa, Bacillus licheniformis
ARYDDVLYFPASRYPETGAHISDAIKAGHADVCTIERSGADKRRQESLKGIPTKPGFDRDEWPMAMCEEGGKGASVRYVSSSDNRGAGSWVGNRLNGYADGTRILFIVQ

SEQ ID NO: 6 - protein, 109 aa, Bacillus subtilis
ASSYDKVLYFPLSRYPETGSHIRDAIAEGHPDICTIDDGADKRREESLKGIPTKPGYDRDEWPMAVCEEGGAGADVRYVTPSDNRGAGSWVGNQMSSYPDGTRVLFIVQ

SEQ ID NO: 7 - protein, 109 aa, Bacillus licheniformis
ARYDDILYFPASRYPETGAHISDAIKAGHSDVCTIERSGADKRRQESLKGIPTKPGFDRDEWPMAMCEEGGKGASVRYVSSSDNRGAGSWVGNRLSGFADGTRILFIVQ

SEQ ID NO: 8 - protein, 204 aa, Aspergillus oryzae
KTGSGDSQSDPIKADLEVKGQSALPFDVDCWAILCKGAPNVLQRVNEKTKNSNRDRSGANKGPFKDPQKWGIKALPPKNPSWSAQDFKSPEEYAFASSLQGGTNAILAPVNLASQNSQGGVLNGFYSANKVAQFDPSKPQQTKGTWFQITKFTGAAGPYCKALGSNDKSVCDKNKNIAGDWGFDPAKWAYQYDEKNNKFNYVGK

SEQ ID NO: 9 - protein, 188 aa, Trichoderma harzianum
APAPMPTPPGIPTESSARTQLAGLTVAVAGSGTGYSRDLFPTWDAISGNCNAREYVLKRDGEGVQVNNACESQSGTWISPYDNASFTNASSLDIDHMVPLKNAWISGASSWTTAQREALANDVSRPQLWAVSASANRSKGDRSPDQWKPPLTSFYCTYAKSWIDVKSFYKLTITSAEKTALSSMLDTC

SEQ ID NO: 10 - protein, 361 aa, Aggregatibacter actinomycetemcomitans
NCCVKGNSIYPQKTSTKQTGLMLDIARHFYSPEVIKSFIDTISLSGGNFLHLHFSDHENYAIESHLLNQRAENAVQGKDGIYINPYTGKPFLSYRQLDDIKAYAKAKGIELIPELDSPNHMTAIFKLVQKDRGVKYLQGLKSRQVDDEIDITNADSITFMQSLMSEVIDIFGDTSQHFHIGGDEFGYSVESNHEFITYANKLSYFLEKKGLKTRMWNDGLIKNTFEQINPNIEITYWSYDGDTQDKNEAAERRDMRVSLPELLAKGFTVLNYNSYYLYIVPKASPTFSQDAAFAAKDVIKNWDLGVWDGRNTKNRVQNTHEIAGAALSIWGEDAKALKDETIQKNTKSLLEAVIHKTNGDE

SEQ ID NO: 11 - protein, 541 aa, Ascobolus stictoideus
QTYTLEAEAGTLTGVTVMNEIAGFSGTGYVGGWDEDADTVSLTFTSDATKLYDVKIRYSGPYGSKYTRISYNGATGGDISLPETTEWATVNAGQALLNAGSNTIKLHNNWGWYLIDAVILTPSVPRPPHQVTDALVNTNSNAVTKQLMKFLVSKYHKAYITGQQELHAHQWVEKNVGKSPAILGLDFMDYSPSRVEFGTTSQAVEQAIDFDKRGGIVTFAWHWNAPSGLINTPGSEWWRGFYTEHTTFDVAAALQNTTNANYNLLIRDIDAIAVQLKRLQTAGVPVLWRPLHEAEGGWFWWGAKGPEPAKKLYKILYDRLTNYHKLNNLIWVWNSVAKDWYPGDEIVDVLSFDSYPAQPGDHGPVSAQYNALVELGKDKKLIAATEVGTIPDPDLMQLYESYWSFFVTWEGEFIENGVHNSLEFLKKLYNNSFVLNLDTIQGWKNGAGSSTTTVKSTTTTPTTTIKSTTTTPVTTPTTVKTTTTPTTTATTVKSTTTTAGPTPTAVAGRWQQCGGIGFTGPTTCEAGTTCNVLNPYYSQCL

SEQ ID NO: 12 - protein, 526 aa, Chaetomium virescens
PRDPGATARTFEAEDATLAGTNVDTALSGFTGTGYVTGFDQAADKVTFTVDSASTELYDLSIRVAAIYGDKRTSVVLNGGASSEVYFPAGETWTNVAAGQLLLNQGSNTIDIVSNWGWYLIDSITLTPSTPRPAHQINEAPVNAAADKNAKALYSYLRSIYGKKILSGQQELSLSNWIAQQTGKTPALVSVDLMDYSPSRVERGTVGTAVEEAIQHHNRGGIVSVLWHWNAPTGLYDTEEHRWWSGFYTSATDFDVAAALSSTTNANYTLLIRDIDAIAVQLKRLQSAGVPVLFRPLHEAEGGWFWWGAKGPEPAKKLWGILYDRVTNHHQINNLLWVWNSILPEWYPGDATVDILSADVYAQGNGPMSTQYNQLIELGKDKKMIAAAEVGAAPLPDLLQAYEAHWLWFTVWGDSFINNADWNSLDTLKKVYTSDYVLTLDEIQGWQGSTPSATTTSSTTTPSATTTTTTPSTTATTATPSATTTASPVTYAEHWGQCAGKGWTGPTTCRPPYTCKYQNDWYSQCL

SEQ ID NO: 13 - protein, 452 aa, Preussia aemulans
QTVIYQAEQAKLSGVTVEFSIIKQVVGTGYVEGFDESTDSITFTVESTTAALYDLALTYNGPYGDKYTNVVLNNAAGSQVSLPATTAWTTVPAGQVLLNAGANTIQIQNNWGWYLVDSISLKPAATRGAHQITTKPVNKNANSDAKALLKYLGSIYGKKILSGQQDLSSLDWVTKNVGKTPAVLGLDTMDYSESRKSRGAVSTDVDKAIAFAKKGGIVTFCWHWGAPTGLFDSAAQPWYRGFYTDATDFNIETALKDTTNANYTLLMKDIDTIAVQLKKLQDAGVPVIWRPLHEAEGGWFWWGAKGPEPAKKLWKIMYDRLTNQHGLNNLVWTWNSVAPNWYPGDDTVDIVSADTYSQGDHGPISATYNNLLALTNDTKIIAAAEIGSVMEPAQLQAYQADWVYFCVWSGEFIDGGVWNSLDFLKKVYNDPYVLTLDEIQGWKTARGKPRVS

SEQ ID NO: 14 - protein, 312 aa, Yunnania penicillata
APSTTPVNEKATDAAKNLLSYLVEQAANGVTLSGQQDLESAQWVSDNVGKWPAILGIDFMDYSPSRVEYGAVGSTVPDAISYDSDGGIVTFCWHWGSPSGTYNTTDQPWWSNFYTEATAFDIAAAMDDPDSADYNLLVRDIDAISELLLQLQDLDIPILWRPLHEAEGGWFWWGAKGPEACIALYRLMFDRMTNHHGLNNLLWVWNSVDPSWYPGNDVVDIVSADIYADAGDHSPQEETFASLQSLTGDTKLVALGEVGNIPDPASTGGVADWAYWVTWNGDFIKGEDYNPLEYKKEVFSAENIITRDEVDV

SEQ ID NO: 15 - protein, 327 aa, Myrothecium roridum
GTIENRQWLTYNPVDSAATTEARALLRYIQSQYGWRYLSGQQERAEVQWLKSNIGKTPAIQGSDLIDYSPSRVSYGATSTAVEDAIAFDRQGGIVTFTWHWNAPNCLYNSADQPWYFGFYTKATCFNIQAALAQGSNGADYKLLIRDIDAIAVQLKRLRDAKVPILFRPLHEPDGAWFWWGAKGSGPFKQLWDILYDRLTKYHGLHNMLWVCNTEKSDWYPGNNKCDIATTDVYVNAGDHSVQKSHWDALYGVSGGQRILALGEVGVIPDPERQASENVPWAYWMTWNGYFIRDGNYNSRNFLQSTFSNARVVTLDGTSPLGNWKSS

SEQ ID NO: 16 - protein, 463 aa, Streptomyces davawensis
DATIVINPGTRYGTWEGWGTSLAWWGNVFGTRDDFADLFFTTKSVTYNGTSLPGLGLNIARYNLGACSWNAVNGETMVKSPNIPAFKQIEGFWQDWNNEDPTSSAWDWTADATQRAMLVKATQRGAVTELFANSPMWWMCYNHNPSGAADGGNNLQTWNYRQHASHLAAVALYARTNWGVNFATVDPFNEPASSWWTASGTQEGCHLDPAVQAAVLPYMRSELDKRGLTGVRISASDETNYDTARSTWSSFGSATKALVSQVNVHGYQGTGGRRDLLYTDVVTTSGKKLWNSETGDSDGTGLSMARNLCYDFRWLHPTAWCYWQVMDPSTGWAMIAYDANTLQPTTVQPKYYVMAQFSRHIRPGMTILDTGVSFAAAAYDASARRLVLVAVNTSTSPQTFTFDLSRFTTVTGGSGGLVPRWNTVTGGGDMYRAYTNTYVTGKSVSATFAAGSVQTLQVDGVTT

(19) United States
(12) Patent Application Publication
(10) Pub. No.: US 2019/0264140 A1
(43) Pub. Date: Aug. 29, 2019

(54) METHODS OF CLEANING

(71) Applicant: The Procter & Gamble Company

(72) Inventors: Neil Joseph LANT, Newcastle upon Tyne (GB); Philip Frank SOUTER, Northumberland (GB); Montserrat Guadalupe VASQUEZ VALDIVIESO, Newcastle upon Tyne (GB)

(21) Appl. No.: 16/270,630

(22) Filed: Feb. 8, 2019

(30) Foreign Application Priority Data
Feb. 28, 2018 (EP) 18159330.2

(51) Int. Cl. C11D 3/386; C11D 1/831; C11D 3/395; C11D 11/00

(52) U.S. Cl. CPC C11D 3/38618; C11D 1/831; C11D 1/29; C11D 3/3951; C11D 11/0017; C11D 3/3953

(57) ABSTRACT

Cleaning compositions containing isoamylase enzymes capable of breaking alpha-1,6-glycoside linkages (glycogen-debranching enzymes), and mixtures thereof and further amylases, and methods of cleaning using the cleaning compositions and use of the cleaning compositions for removal of complex starch-containing stains.

### REFERENCE TO A SEQUENCE LISTING

This application contains a Sequence Listing in computer readable form, which is incorporated herein by reference.

### FIELD OF THE INVENTION

The present invention relates to methods of cleaning using certain isoamylase enzymes capable of breaking alpha-1,6-glycoside linkages (glycogen-debranching enzymes), and mixtures thereof.

### BACKGROUND OF THE INVENTION

The laundry detergent formulator is constantly aiming to improve the performance of detergent compositions. Starchy soils comprise polymeric carbohydrate consisting of glucose units joined by glycosidic bonds. A big proportion of many starch soils is amylopectin and this contains alpha-1,6 glycosidic bonds. One common ingredient used by detergent formulators to help remove starchy stains are amylase enzymes, typically having primary activity in attacking alpha-1,4 glycosidic bonds in the starch. However, starchy soils are often part of a more chemically complex soil, combined with other soil materials such as oils and proteins, making complete soil removal extremely challenging. Incomplete soil removal still results, in particular in short wash cycles and at low temperatures, in spite of attempts to deliver improved starch breakdown, including by bringing together enzymes that attack alpha-1,4 and alpha-1,6 glycoside bonds, for example using amylases in combination with pullulanases. Although some specific pullulanases have glycogen-debranching activity, that activity is typically for the specific pullulan substrate for which isoamylases have no activity. Without being bound to theory, we believe that proteins, fats and other component in the complex soil stains are locking down starch soils.

There is therefore still a need for improved cleaning processes that provide stain removal benefits in cold, quick washes in particular for cleaning starchy soils from laundry. There is also a need for improved cleaning of starchy soils, when the stains are part of complex mixtures with different soils, for example protein and/or fat in intimate mixture with the starch. The present inventors have found that washing processes in which the surface to be cleaned is contacted with an aqueous wash liquor comprising alpha-1,6 glycogen debranching enzymes and a second amylase including those not used in nature for starch breakdown, and nonionic surfactant and optional adjunct, are very effective.

Furthermore, the present inventors have surprisingly found that a combination of an amylase having primary activity for alpha-1,4 glycosidic bonds and a specific glycogen debranching enzyme with nonionic surfactant can lead to superior stain removal in complex soils.

### SUMMARY OF THE INVENTION

The present invention relates to a composition comprising a) a glycogen-debranching enzyme having activity to 1,6-glucosidic linkages; b) a second amylase having activity to alpha-1,4-glycosidic bonds and exhibiting at least 70%, preferably at least 80%, more preferably at least 85% or at least 90% identity with SEQ ID NO:2, the wild-type enzyme from Bacillus SP722; and c) a cleaning adjunct.

The invention also relates to a method of cleaning a surface, comprising (i) forming an aqueous wash liquor comprising a) a glycogen-debranching enzyme having activity to 1,6-glucosidic linkages, b) a second amylase, having activity to alpha-1,4-glycosidic bonds and exhibiting at least 70%, preferably at least 80%, more preferably at least 85% or at least 90% identity with SEQ ID NO:2, the wild-type enzyme from Bacillus SP722; c) a cleaning adjunct; and d) water; and ii) contacting a surface with the aqueous wash liquor for from 1 to 50 minutes in a washing step; and (iii) optionally rinsing and drying said surface.

Preferably the surface is contacted with the aqueous wash liquor for from 1 to 40 minutes, most preferably from 1 to 30 minutes. Preferably the temperature of the aqueous wash liquor is from 5 to 40° C., preferably from 5 to 30° C., preferably from 5 to 20° C. Preferably the surface comprises textile. Preferably the surface comprises hard surfaces such as in dishwashing, automatic or hand-dishwashing.

Preferred glycogen-debranching enzyme is selected from variants of SEQ ID NO: 1. Preferably the glycogen-debranching enzyme has at least 60% identity to SEQ ID NO: 1.

Preferably the second amylase comprises a variant exhibiting at least 70%, preferably at least 80%, more preferably at least 85% or at least 90% identity with SEQ ID NO:2 and has deletions in the 183 and 184 positions.

The present invention also relates to use of a composition comprising a glycogen debranching enzyme, preferably having activity to 1,6-glucosidic linkages, and a second amylase having activity to alpha-1,4-glycosidic bonds and exhibiting at least 70%, preferably at least 80%, more preferably at least 85% or at least 90% identity with SEQ ID NO:2, the wild-type enzyme from Bacillus SP722 and a cleaning adjunct for complex starch-containing soil removal.

### DETAILED DESCRIPTION OF THE INVENTION

The components of the compositions and processes of the present disclosure are described in more detail below.

As used herein, the articles “a” and “an” when used in a claim, are understood to mean one or more of what is claimed or described. As used herein, the terms “include,” “includes,” and “including” are meant to be non-limiting. The compositions of the present invention can comprise, consist essentially of, or consist of, the components of the present invention.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein, the term “etheramine” includes the term “polyetheramine” and includes amines that have one or more ether groups.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

As used herein, the term “alkoxy” is intended to include C1-C8 alkoxy and C1-C8 alkoxy derivatives of polyols having repeating units such as butylene oxide, glycidol oxide, ethylene oxide or propylene oxide.

As used herein, unless otherwise specified, the terms “alkyl” and “alkyl capped” are intended to include C1-C18 alkyl groups, or even C1-C6 alkyl groups.

As used herein, unless otherwise specified, the term “aryl” is intended to include C3-12 aryl groups.

As used herein, unless otherwise specified, the term “arylalkyl” and “alkaryl” are equivalent and are each intended to include groups comprising an alkyl moiety bound to an aromatic moiety, typically having C1-C18 alkyl groups and, in one aspect, C1-C6 alkyl groups.

The terms “ethylene oxide,” “propylene oxide” and “butylene oxide” may be shown herein by their typical designation of “EO,” “PO” and “BO,” respectively.

As used herein, the term “cleaning and/or treatment composition” includes, unless otherwise indicated, granular, powder, liquid, gel, paste, unit dose, bar form and/or flake type washing agents and/or fabric treatment compositions, including but not limited to products for laundering fabrics, fabric softening compositions, fabric enhancing compositions, fabric freshening compositions, and other products for the care and maintenance of fabrics, and combinations thereof. Such compositions may be pre-treatment compositions for use prior to a washing step or may be rinse added compositions, as well as cleaning auxiliaries, such as bleach additives and/or “stain-stick” or pre-treat compositions or substrate-laden products such as dryer added sheets.

As used herein, “cellulosic substrates” are intended to include any substrate which comprises cellulose, either 100% by weight cellulose or at least 20% by weight, or at least 30% by weight or at least 40 or at least 50% by weight or even at least 60% by weight cellulose. Cellulose may be found in wood, cotton, linen, jute, and hemp. Cellulosic substrates may be in the form of powders, fibers, pulp and articles formed from powders, fibers and pulp. Cellulosic fibers, include, without limitation, cotton, rayon (regenerated cellulose), acetate (cellulose acetate), triacetate (cellulose triacetate), and mixtures thereof. Typically, cellulosic substrates comprise cotton. Articles formed from cellulosic fibers include textile articles such as fabrics. Articles formed from pulp include paper.

As used herein, the term “maximum extinction coefficient” is intended to describe the molar extinction coefficient at the wavelength of maximum absorption (also referred to herein as the maximum wavelength), in the range of 400 nanometers to 750 nanometers.

As used herein “average molecular weight” is reported as a weight average molecular weight, as determined by its molecular weight distribution; as a consequence of their manufacturing process, polymers disclosed herein may contain a distribution of repeating units in their polymeric moiety.

As used herein “identity” or “sequence identity” is the relatedness between two amino acid sequences or between two nucleotide sequences.

For purposes of the present invention, the degree of sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment)

Alternatively, the parameters used may be gap open penalty of 10, gap extension penalty of 0.5, and the EDNAFULL (EMBOSS version of NCBI NUC4.4) substitution matrix. The output of Needle labeled “longest identity” (obtained using the -nobrief option) is used as the percent identity and is calculated as follows:

(Identical Deoxyribonucleotides×100)/(Length of Alignment−Total Number of Gaps in Alignment).

As used herein, the term “alteration” or “modification” may be a substitution, deletion and/or insertion.

As used herein, the term “substitution” means replacement of one amino acid with another amino acid. For an amino acid substitution, the following nomenclature is used: Original amino acid, position, substituted amino acid. Accordingly, the substitution of e.g. threonine at position 226 with alanine is designated as “Thr226Ala” or “T226A”. Multiple mutations are separated by addition marks (“+”), e.g., “Gly205Arg+Ser411Phe” or “G205R+S411F”, representing substitutions at positions 205 and 411 of glycine (G) with arginine (R) and serine (S) with phenylalanine (F), respectively.

As used herein, the term “deletion” means deletion of an amino acid. For an amino acid deletion, the following nomenclature is used: Original amino acid, position, *. Accordingly, the deletion of glycine at position 181 is designated as “Ser181*” or “S181*”. Multiple deletions are separated by addition marks (“+”), e.g., “Ser181*+Thr182*” or “S181*+T182*”.

As used herein, the term “insertion” means an additional amino acid is inserted. For an amino acid insertion, the following nomenclature is used: Original amino acid, position, original amino acid, inserted amino acid. Accordingly, the insertion of lysine after e.g. glycine at position 195 is designated “Gly195GlyLys” or “G195GK”. An insertion of multiple amino acids is designated [Original amino acid, position, original amino acid, inserted amino acid #1, inserted amino acid #2; etc.]. For example, the insertion of lysine and alanine after glycine at position 195 is indicated as “Gly195GlyLysAla” or “G195GKA”.

In such cases the inserted amino acid residue(s) are numbered by the addition of lower case letters to the position number of the amino acid residue preceding the inserted amino acid residue(s). In the above example, the sequence would thus be:

| Parent: | Variant: |
|---|---|
| 195 | 195 195a 195b |
| G | G - K - A |

Multiple Alterations/Modifications.

Variants comprising multiple alterations/modifications are separated by addition marks (“+”), e.g., “Arg170Tyr+Gly195Glu” or “R170Y+G195E” representing a substitution of arginine and glycine at positions 170 and 195 with tyrosine and glutamic acid, respectively.

Where different alterations can be introduced at a position, the different alterations are separated by a comma, e.g., “Arg170Tyr,Glu” represents a substitution of arginine at position 170 with tyrosine or glutamic acid. Thus, “Tyr167Gly,Ala+Arg170Gly,Ala” designates the following variants:

“Tyr167Gly+Arg170Gly”, “Tyr167Gly+Arg170Ala”, “Tyr167Ala+Arg170Gly”, and “Tyr167Ala+Arg170Ala”.

As used herein “parent” or “parent amylase” means an alpha-amylase to which an alteration is made to produce the enzyme variants of the present invention. The parent of each respective variant may be a naturally occurring (wild-type) polypeptide or a variant thereof.

As used herein the term “variant” refers to a polypeptide that contains an amino acid sequence that differs from a wild type or reference sequence. A variant polypeptide can differ from the wild type or reference sequence due to a deletion, insertion, or substitution of a nucleotide(s) relative to said reference or wild type nucleotide sequence. The reference or wild type sequence can be a full-length native polypeptide sequence or any other fragment of a full-length polypeptide sequence. A polypeptide variant generally has at least about 70% amino acid sequence identity with the reference sequence, but may include 75% amino acid sequence identity within the reference sequence, 80% amino acid sequence identity within the reference sequence, 85% amino acid sequence identity with the reference sequence, 86% amino acid sequence identity with the reference sequence, 87% amino acid sequence identity with the reference sequence, 88% amino acid sequence identity with the reference sequence, 89% amino acid sequence identity with the reference sequence, 90% amino acid sequence identity with the reference sequence, 91% amino acid sequence identity with the reference sequence, 92% amino acid sequence identity with the reference sequence, 93% amino acid sequence identity with the reference sequence, 94% amino acid sequence identity with the reference sequence, 95% amino acid sequence identity with the reference sequence, 96% amino acid sequence identity with the reference sequence, 97% amino acid sequence identity with the reference sequence, 98% amino acid sequence identity with the reference sequence, 98.5% amino acid sequence identity with the reference sequence or 99% amino acid sequence identity with the reference sequence.

As used herein, “wild-type enzyme” means an enzyme expressed by a naturally occurring microorganism, such as a bacterium, yeast, or filamentous fungus found in nature.

As used herein, the term “solid” includes granular, powder, bar and tablet product forms.

As used herein, the term “fluid” includes liquid, gel, paste, and gas product forms.

### Cleaning Composition

The present disclosure relates to cleaning and/or treatment compositions. The cleaning composition may be a laundry or hard surface cleaning compositions or additives. Examples of hard surface cleaning compositions include for example dishwashing detergents or additives for dish-washing which may be for automatic dishwashing or handwashing. The cleaning composition is preferably a dishwashing composition, preferably an automatic dishwashing detergent or a laundry composition (such as a heavy duty liquid or solid detergent composition).

The cleaning compositions may be in any suitable form. The composition can be selected from a liquid, solid, or combination thereof. As used herein, “liquid” includes free-flowing liquids, as well as pastes, gels, foams and mousses. Non-limiting examples of liquids include light duty and heavy duty liquid detergent compositions, fabric enhancers, detergent gels commonly used for laundry, bleach and laundry additives. Gases, e.g., suspended bubbles, or solids, e.g. particles, may be included within the liquids. A “solid” as used herein includes, but is not limited to, powders, agglomerates, and mixtures thereof. Non-limiting examples of solids include: granules, micro-capsules, beads, noodles, and pearlised balls. Beads, noodles and pearlized balls in particular may be additives for fabric treatment. Solid compositions may provide a technical benefit including, but not limited to, through-the-wash benefits, pre-treatment benefits, and/or aesthetic effects.

The cleaning composition may be in the form of a unitized dose article, such as a tablet or in pouch form. Such pouches typically include a water-soluble film, such as a polyvinyl alcohol water-soluble film, that at least partially encapsulates a composition. Suitable films are available from MonoSol, LLC (Indiana, USA). The composition can be encapsulated in a single or multi-compartment pouch. A multi-compartment pouch may have at least two, at least three, or at least four compartments. A multi-compartmented pouch may include compartments that are side-by-side and/or superposed. The composition contained in the pouch may be liquid, solid (such as powders), or combinations thereof.

### Glycogen-Debranching Enzyme

The glycogen debranching enzyme is a glycoside hydrolase, preferably from family 13. Preferably the glycogen-debranching enzyme belongs to EC 3.2.1.68. Preferably the glycogen-debranching enzyme has activity for 1,6-glucosidic linkages, and most preferably shows distinct substrate specificity toward limit dextrins and phosphorylase limit dextrin. Preferably the glycogen-debranching enzyme is from family 13. The glycogen-debranching enzyme preferably has at least 60% sequence identity to SEQ ID NO: 1.

Preferably the glycogen-debranching enzyme is a variant of SEQ ID NO: 1. The glycogen-debranching enzyme may be of any suitable origin such as yeasts, fungi and bacteria. Preferably however, they are bacterial. Suitable microbial sources are for example Pseudomonas, Corynebacterium glutamicum or E. coli, E. coli is preferred.

The glycogen-debranching enzyme may be used singly or in combination. They may be used in non-purified or purified form, irrespective of the methods of purification. They may be incorporated into the cleaning composition in liquid form or in the form of a particle (solid form), often known as an enzyme prill. They may be added into a cleaning composition via a premix with other enzymes such as other amylase, lipase, protease, cellulase, mannanase, pectate lyase, nuclease, cutinase, or mixtures thereof. The premix may be in liquid or solid form. Preferably the isoamylase is present in the cleaning composition of the invention in an amount at least 0.01 mg, preferably from about 0.05 to about 10, more preferably from about 0.1 to about 6, especially from about 0.2 to about 5 mg of active isoamylase/g of composition.

Sequence ID NO: 1
MTQLAIGKPAPLGAHYDGQGVNFTLFSAHAERVELCVFDANGQEHRYDLP
GHSGDIWHGYLPDARPGLRYGYRVHGPWQPAEGHRFNPAKLLIDPCARQI
DGEFKDNPLLHAGHNEPDYRDNAAIAPKCVVVVDHYDWEDDAPPRTPWGS
TIIYEAHVKGLTYLHPEIPVEIRGTYKALGHPVMINYLKQLGITALELLP
VAQFASEPRLQRMGLSNYWGYNPVAMFALHPAYACSPETALDEFRDAIKA
LHKAGIEVILDIVLNHSAELDLDGPLFSLRGIDNRSYYWIREDGDYHNWT
GCGNTLNLSHPAVVDYASACLRYWVETCHVDGFRFDLAAVMGRTPEFRQD
APLFTAIQNCPVLSQVKLIAEPWDIAPGGYQVGNFPPLFAEWNDHFRDAA
RRFWLHYDLPLGAFAGRFAASSDVFKRNGRLPSAAINLVTAHDGFTLRDC
VCFNHKHNEANGEENRDGTNNNYSNNHGKEGLGGSLDLVERRRDSIHALL
TTLLLSQGTPMLLAGDEHGHSQHGNNNAYCQDNQLTWLDWSQASSGLTAF
TAALIHLRKRIPALVENRWWEEGDGNVRWLNRYAQPLSTDEWQNGPKQLQ
ILLSDRFLIAINATLEVTEIVLPAGEWHAIPPFAGEDNPVITAVWQGPAH
GLCVFQR

### Second Amylase

The second amylase has activity to alpha-1,4-glycosidic bonds and exhibits at least 70%, preferably at least 80%, more preferably at least 85%, preferably at least 90% identity with SEQ ID NO:2, the wild-type enzyme from Bacillus SP722.

### Parent Alpha-Amylase

The parent alpha-amylase may be any suitable amylase. Preferably the parent is a polypeptide with at least 60% preferably at least 70%, preferably at least 80% sequence identity with the polypeptide set forth in SEQ ID NO: 2, for example preferably at least 85%, at least 90%, e.g. at least 92%, at least 93%, at least 94%, at least 95%, at least 96%, at least 97%, at least 98%, at least 99, or 100%, which has alpha-amylase activity. In one aspect, the amino acid sequence of the parent alpha-amylase differs by no more than ten amino acids, e.g. by five amino acids, by four amino acids, by three amino acids, by two amino acids, and by one amino acid from the polypeptide of SEQ ID NO: 2. The parent alpha-amylase preferably comprises or consists of the amino acid sequence of SEQ ID NO: 2. In another embodiment, the parent alpha-amylase is an allelic variant of the polypeptide of SEQ ID NO: 2. The parent alpha-amylase may also be a polypeptide with at least 80% sequence identity, such as at least 85%, at least 90%, e.g. at least 92%, at least 93%, at least 94%, at least 95%, at least 96%, at least 97%, at least 98%, at least 99, or 100% identity with any of polypeptides having SEQ ID NO: 2, 3, 4, 5, 6, 7 or 8 from WO2018/144399. In one aspect, the amino acid sequence of the parent alpha-amylase differs by no more than ten amino acids, e.g. by five amino acids, by four amino acids, by three amino acids, by two amino acids, and by one amino acid from the polypeptide of any of the polypeptides having SEQ ID NO: 2, 3, 4, 5, 6, 7 or 8 from WO2018/144399. The parent may be obtained from microorganisms of any genus. For purposes of the present invention, the term “obtained from” as used herein in connection with a given source shall mean that the parent encoded by a polynucleotide is produced by the source or by a cell in which the polynucleotide from the source has been inserted. In one aspect, the parent is secreted extracellularly.

The parent may be a bacterial alpha-amylase. For example, the parent may be a gram-positive bacterial polypeptide such as a Bacillus, Clostridium, Enterococcus, Geobacillus, Lactobacillus, Lactococcus, Oceanobacillus, Staphylococcus, Streptococcus, or Streptomyces alpha-amylase, or a gram-negative bacterial polypeptide such as a Campylobacter, E. coli, Flavobacterium, Fusobacterium, Helicobacter, Ilyobacter, Neisseria, Pseudomonas, Salmonella, or Ureaplasma alpha-amylase.

In one aspect, the parent is a Bacillus alkalophilus, Bacillus amyloliquefaciens, Bacillus brevis, Bacillus circulans, Bacillus clausii, Bacillus coagulans, Bacillus firmus, Bacillus lautus, Bacillus lentus, Bacillus licheniformis, Bacillus megaterium, Bacillus pumilus, Bacillus stearothermophilus, Bacillus subtilis, or Bacillus thuringiensis alpha-amylase.

In another aspect, the parent is a Streptococcus equisimilis, Streptococcus pyogenes, Streptococcus uberis, or Streptococcus equi subsp. Zooepidemicus alpha-amylase.

In another aspect, the parent is a Streptomyces achromogenes, Streptomyces avermitilis, Streptomyces coelicolor, Streptomyces griseus, or Streptomyces lividans alpha-amylase.

In another aspect, the parent is a Bacillus sp. alpha-amylase, e.g., the alpha-amylase of SEQ ID NO: 2.

It will be understood that for the aforementioned species, the invention encompasses both the perfect and imperfect states, and other taxonomic equivalents, e.g., anamorphs, regardless of the species name by which they are known. Those skilled in the art will readily recognize the identity of appropriate equivalents.

Strains of these species are readily accessible to the public in a number of culture collections, such as the American Type Culture Collection (ATCC), Deutsche Sammlung von Mikroorganismen und Zellkulturen GmbH (DSM), Centraalbureau Voor Schimmelcultures (CBS), and Agricultural Research Service Patent Culture Collection, Northern Regional Research Center (NRRL).

The parent may be identified and obtained from other sources including microorganisms isolated from nature (e.g., soil, composts, water, etc.) or DNA samples obtained directly from natural materials (e.g., soil, composts, water, etc,) using the above-mentioned probes. Techniques for isolating microorganisms and DNA directly from natural habitats are well known in the art. The polynucleotide encoding a parent may then be derived by similarly screening a genomic or cDNA library of another microorganism or mixed DNA sample. Once a polynucleotide encoding a parent has been detected with a probe(s), the polynucleotide may be isolated or cloned by utilizing techniques that are known to those of ordinary skill in the art (see, e.g., Sambrook et al., 1989, supra).

The parent may be a hybrid polypeptide in which a portion of one polypeptide is fused at the N-terminus or the C-terminus of a portion of another polypeptide.

The parent may also be a fused polypeptide or cleavable fusion polypeptide in which one polypeptide is fused at the N-terminus or the C-terminus of another polypeptide. A fused polypeptide is produced by fusing a polynucleotide encoding one polypeptide to a polynucleotide encoding another polypeptide. Techniques for producing fusion polypeptides are known in the art and include ligating the coding sequences encoding the polypeptides so that they are in frame and that expression of the fused polypeptide is under control of the same promoter(s) and terminator. Fusion proteins may also be constructed using intein technology in which fusions are created post-translationally (Cooper et al., 1993, EMBO J. 12: 2575-2583; Dawson et al., 1994, Science 266: 776-779).

A fusion polypeptide can further comprise a cleavage site between the two polypeptides. Upon secretion of the fusion protein, the site is cleaved releasing the two polypeptides. Examples of cleavage sites include, but are not limited to, the sites disclosed in Martin et al., 2003, J. Ind. Microbiol. Biotechnol. 3: 568-576; Svetina et al., 2000, J. Biotechnol. 76: 245-251; Rasmussen-Wilson et al., 1997, Appl. Environ. Microbiol. 63: 3488-3493; Ward et al., 1995, Biotechnology 13: 498-503; and Contreras et al., 1991, Biotechnology 9: 378-381; Eaton et al., 1986, Biochemistry 25: 505-512; Collins-Racie et al., 1995, Biotechnology 13: 982-987; Carter et al., 1989, Proteins: Structure, Function, and Genetics 6: 240-248; and Stevens, 2003, Drug Discovery World 4: 35-48.

A suitable second amylase may be of bacterial or fungal origin. Chemically or genetically modified mutants (variants) are included.

Preferably the second amylase comprises an alteration at one or more positions selected from the group consisting of 1, 7, 109, 134, 140, 189, 193, 195, 197, 198, 200, 203, 206, 210, 212, 213, 243, 260, 262, 280, 284, 304, 320, 323, 347, 391, 439, 469, 476, 477. The variant may comprise from two to 30, or 2 to 20 or 2 to 3, 4, 5, 6, 7, 8, 9 or 10 alterations at positions selected from this group, preferably substitutions.

Preferably the variant comprises an alteration at one or two or three or four or more positions corresponding to positions selected from the group consisting of 193, 195, 197, 198, 200, 203, 206, 210, 212, 213 and 243. Preferably the substitution at 193 is [G,A,S,T or M]; position 195 is [F,W,Y,L,I or V]; position 197 is [F,W,Y,L,I or V]; position 198 is [Q or N]; position 200 is [F,W,Y,L,I or V]; position 203 is [F,W,Y,L,I or V]; position 206 is [F,W,Y,N,L,I,V or H]; position 210 is [F,W,Y,L,I or V]; position 212 is [F,W,Y,L,I or V] or position 213 is [G,A,S,T or M], preferably the variant comprises N195F+V206Y+Y243F.

Preferably the variant comprises a substitution at one, two, three or four positions selected from the group consisting of, 134, 140, 189, 260, 262, 284, 304, 347, 439, 469 and 476 and 477. Preferably the variant comprises a substitution at two, three or four or more positions selected from the group consisting of 134, 140, 189, 260, 304, 476, 477, preferably selected from the group consisting of D134E, W140YF, E260GHIKNRTY, W189EGT, W284DFR, G304R, W439RG, G476EK, G477EKMR, preferably from G304R, W140Y, E260G and G476K. Preferably the variant further comprises one or more substitutions selected from the group consisting of N195F, V206Y, Y243F, G109A, G273DV, G337N, K72R, R181H, S303G and Y100I.

A preferred variant comprises alterations in the positions selected from the group of positions consisting of: 1+7; 1+109; 1+280; 1+284; 1+320; 1+323; 1+391; 109+280; 109+284; 109+320; 109+323; 109+391; 7+109; 7+280; 7+284; 7+320; 7+320; 7+323; 7+391; 280+284; 280+320; 280+323; 280+391; 284+320; 284+323; 284+391; 320+323; 320+391; and 323+391, wherein numbering is according to SEQ ID NO: 2.

A preferred variant comprises or consists of substitutions in the positions, corresponding to the positions of the polypeptide of SEQ ID NO: 2, selected from the group consisting of:

### W140Y+N195F+V206Y+Y243F+E260G+G477E,

### W140Y+N195F+V206Y+Y243F+E260T+W284D,

### W140Y+N195F+V206Y+Y243F+W284D,

### G109A+W140Y+N195F+V206Y+Y243F+E260G,

### W140Y+N195F+V206Y+Y243F+E260G,

### N195F+V206Y+Y243F+E260K+W284D,

### D134E+G476E,

### W140Y+N195F+V206Y+Y243F+E260G+G476E,

### W140Y+W189G+N195F+V206Y+Y243F+E260G,

### W140Y+N195F+V206Y+Y243F+E260G+S303G,

### W140Y+W189T+N195F+V206Y+Y243F+E260G,

### W140Y+N195F+V206Y+Y243F+E260G+W284D,

### Y100I+W140Y+N195F+V206Y+Y243F+E260G,

### W140Y+N195F+V206Y+Y243F+E260G+G337N,

### W140Y+N195F+V206Y+Y243F+E260G+W439R,

### G109A+W140Y+E194D+N195F+V206Y+Y243F+E260G,

### G109A+W140Y+N195F+V206Y+Y243F+E260G+G476E,

### T51I+Y100I+G109A+W140Y+N195F+V206Y+Y243F+E260G,

### T51I+G109A+W140Y+N195F+V206Y+Y243F+E260G+W439R,

### T51I+S52Q+N54K+G109A+W140Y+N195F+V206Y+Y243F+E260G+G476E,

### W140Y+N195F+V206Y+Y243F+E260G+G304R+G476K,

### W140Y+N195F+V206Y+Y243F+E260G+W284R+G477K,

### W140Y+N195F+V206Y+Y243F+E260G+W284F+G477R,

### N195F+V206Y+Y243F+E260G+W284D,

### H1*+G109A+N280S+E391A,

### H1*+G7K+G109A+N280S+E391A,

### H1*+G7E+G109A+N280S+E391A,

### H1*+G7N+G109A+N280S+E391A,

### H1*+G7Q+G109A+N280S+E391A,

### H1*+G7L+G109A+N280S+E391A,

### H1*+G7D+G109A+N280S+E391A,

### H1*+G109A+N280S+K320A+E391A,

### H1*+G109A+N280S+K320M+E391A,

### H1*+G109A+N280S+K320T+E391A,

### H1*+G109A+N280S+K320V+E391A,

### H1*+G109A+N280S+M323R+E391A,

### H1*+G109A+N280S+K320S+E391A,

### H1*+G109A+N280S+E391V,

### H1*+G109A+W284R+E391A,

### H1*+G109A+W284F+E391A,

### H1*+G109A+N280S+K320A+M323S+E391A,

### H1*+G109A+N280S+W284F+E391A,

### H1*+G109A+N280S+M323N+E391A,

### H1*+G109A+N280S+M323K+E391A,

### H1*+G109S+N280S+E391A,

### H1*+G109A+W284H+E391A,

### H1*+G109A+N280S+K320A+M323N+E391A,

### H1*+G7A+G109A+N280S+E391A,

### H1*+G7A+G109A+N280S+W284H+K320A+M323N+E391A,

### G7A+W284H+K320A+M323N,

### G7A+K320A+M323N,

### K320A,

### G7A+K320A,

### H1*+G7A+G109A+N280S+E391A,

### H1*+G109A+N280S+W284H+E391A,

### H1*+G109A+N280S+M323S+E391A,

### H1*+G7A+G109A+N280S+K320A+E391A,

### H1*+G7A+G109A+N280S+M323S+E391A,

### H1*+G7A+G109A+N280S+M323N+E391A,

### H1*+G7A+G109A+N280S+W284F+E391A,

### H1*+G7A+G109A+N280S+W284R+E391A,

### H1*+G7A+G109A+N280S+K320A+M323S+E391A,

### H1*+G7A+G109A+W284R+E391A, and

### H1*+G7A+G109A+N280S+K320A+M323N+E391A.

It is particularly preferred that the variant comprises at least one, at least two, or at least three deletions in amino acid region of 181, 182, 183, or 184, for example, G182*+D183* or D183*+G184* in addition to any of the alterations or combinations of alterations mentioned above. Preferred second amylases are variants exhibiting at least 90% identity with SEQ ID NO: 4 in WO06/002643, the wild-type enzyme from Bacillus SP722 (SEQ ID NO: 2 herein), especially variants with deletions in the 183 and 184 positions and variants described in WO 00/60060. The parent of the second amylase may be the alpha-amylase of SEQ ID NO:2 (known as SP722), alternatively, it may mean any suitable alpha-amylase.

Optional Additional Amylase

Suitable optional additional alpha-amylases include those of bacterial or fungal origin which are not the isoamylase and are not the second amylase. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCBI 12289, NCBI 12512, NCBI 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:

(a) variants described in WO 94/02597, WO 94/18314, WO96/23874 and WO 97/43424, especially the variants with substitutions in one or more of the following positions versus the enzyme listed as SEQ ID No. 2 in WO 96/23874: 15, 23, 105, 106, 124, 128, 133, 154, 156, 181, 188, 190, 197, 202, 208, 209, 243, 264, 304, 305, 391, 408, and 444.

(b) variants exhibiting at least 95% identity with the wild-type enzyme from Bacillus sp.707 (SEQ ID NO:7 in U.S. Pat. No. 6,093,562), especially those comprising one or more of the following mutations M202, M208, S255, R172, and/or M261. Preferably said amylase comprises one or more of M202L, M202V, M202S, M202T, M202I, M202Q, M202W, S255N and/or R172Q. Particularly preferred are those comprising the M202L or M202T mutations.

(c) variants described in WO 09/149130, preferably those exhibiting at least 90% identity with SEQ ID NO: 1 or SEQ ID NO:2 in WO 09/149130, the wild-type enzyme from Geobacillus Stearophermophilus or a truncated version thereof.

(d) variants exhibiting at least 89% identity with SEQ ID NO:1 in WO2016091688, especially those comprising deletions at positions H183+G184 and additionally one or more mutations at positions 405, 421, 422 and/or 428.

(e) variants exhibiting at least 60% amino acid sequence identity with the “PcuAmyl α-amylase” from Paenibacillus curdlanolyticus YK9 (SEQ ID NO:3 in WO2014099523).

(f) variants exhibiting at least 70% amino acid sequence identity with the “CspAmy2 amylase” from Cytophaga sp. (SEQ ID NO:1 or 6 in WO2014164777).

(g) variants exhibiting at least 85% identity with AmyE from Bacillus subtilis (SEQ ID NO:1 in WO2009149271).

(h) variants exhibiting at least 90% identity with the wild-type amylase from Bacillus sp. KSM-K38 with accession number AB051102.

(i) variants exhibiting at least 85% identity with the mature amino acid sequence of AAI10 from Bacillus sp (SEQ ID NO:7 in WO2016180748)

(j) variants exhibiting at least 80% identity with the mature amino acid sequence of Alicyclobacillus sp. amylase (SEQ ID NO:8 in WO2016180748) Suitable commercially available additional alpha-amylases include DURAMYL®, LIQUEZYME®, TERMAMYL®, TERMAMYL ULTRA®, SUPRAMYL®, FUNGAMYL®, INTENSA®, and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS®, PREFERENZ S® series (including PREFERENZ S1000® and PREFERENZ 52000®) and PURASTAR OXAM® (DuPont., Palo Alto, Calif.) and KAM® (Kao, 14-10 Nihonbashi Kayabacho, 1-chome, Chuo-ku Tokyo 103-8210, Japan).

### Preparation of Variants

A suitable method for obtaining an enzyme variant essential to the present invention comprises (a) introducing into a parent amylase an alteration at one or more position in the parent amylase; and (b) recovering said variant.

The variants may be prepared using any mutagenesis procedure known in the art, such as site-directed mutagenesis, synthetic gene construction, semi-synthetic gene construction, random mutagenesis, shuffling, etc.

Site-directed mutagenesis is a technique in which one or more (several) mutations are created at one or more defined sites in a polynucleotide encoding the parent.

Site-directed mutagenesis can be accomplished in vitro by PCR involving the use of oligonucleotide primers containing the desired mutation. Site-directed mutagenesis can also be performed in vitro by cassette mutagenesis involving the cleavage by a restriction enzyme at a site in the plasmid comprising a polynucleotide encoding the parent and subsequent ligation of an oligonucleotide containing the mutation in the polynucleotide. Usually the restriction enzyme that digests at the plasmid and the oligonucleotide is the same, permitting sticky ends of the plasmid and insert to ligate to one another. See, e.g., Scherer and Davis, 1979, Proc. Natl. Acad. Sci. USA 76: 4949-4955; and Barton et al., 1990, Nucleic Acids Res. 18: 7349-4966.

Site-directed mutagenesis can also be accomplished in vivo by methods known in the art. See, e.g., U.S. Patent Application Publication No. 2004/0171154; Storici et al., 2001, Nature Biotechnol. 19: 773-776; Kren et al., 1998, Nat. Med. 4: 285-290; and Calissano and Macino, 1996, Fungal Genet. Newslett. 43: 15-16.

Any site-directed mutagenesis procedure can be used in the present invention. There are many commercial kits available that can be used to prepare variants.

Synthetic gene construction entails in vitro synthesis of a designed polynucleotide molecule to encode a polypeptide of interest. Gene synthesis can be performed utilizing a number of techniques, such as the multiplex microchip-based technology described by Tian et al. (2004, Nature 432: 1050-1054) and similar technologies wherein oligonucleotides are synthesized and assembled upon photo-programable microfluidic chips.

Single or multiple amino acid substitutions, deletions, and/or insertions can be made and tested using known methods of mutagenesis, recombination, and/or shuffling, followed by a relevant screening procedure, such as those disclosed by Reidhaar-Olson and Sauer, 1988, Science 241: 53-57; Bowie and Sauer, 1989, Proc. Natl. Acad. Sci. USA 86: 2152-2156; WO 95/17413; or WO 95/22625. Other methods that can be used include error-prone PCR, phage display (e.g., Lowman et al., 1991, Biochemistry 30: 10832-10837; U.S. Pat. No. 5,223,409; WO 92/06204) and region-directed mutagenesis (Derbyshire et al., 1986, Gene 46: 145; Ner et al., 1988, DNA 7: 127).

Mutagenesis/shuffling methods can be combined with high-throughput, automated screening methods to detect activity of cloned, mutagenized polypeptides expressed by host cells (Ness et al., 1999, Nature Biotechnology 17: 893-896). Mutagenized DNA molecules that encode active polypeptides can be recovered from the host cells and rapidly sequenced using standard methods in the art. These methods allow the rapid determination of the importance of individual amino acid residues in a polypeptide.

Semi-synthetic gene construction is accomplished by combining aspects of synthetic gene construction, and/or site-directed mutagenesis, and/or random mutagenesis, and/or shuffling. Semi-synthetic construction is typified by a process utilizing polynucleotide fragments that are synthesized, in combination with PCR techniques. Defined regions of genes may thus be synthesized de novo, while other regions may be amplified using site-specific mutagenic primers, while yet other regions may be subjected to error-prone PCR or non-error prone PCR amplification. Polynucleotide subsequences may then be shuffled.

### Cleaning Adjuncts

The cleaning compositions described herein optionally comprise one or more cleaning adjuncts. Suitable adjuncts preferably comprise at least further surfactant, preferably the nonionic surfactant comprises part of a surfactant system comprising a mixture of surfactants. Suitable adjuncts may include one or more of the following non-limiting list of ingredients: additional surfactant, surfactant system, fabric care benefit agent; detersive enzyme; deposition aid; rheology modifier; builder; chelant; bleach; bleaching agent; bleach precursor; bleach booster; bleach catalyst; bleach activator, encapsulated benefit agents, including where perfume is in the core; perfume; perfume loaded zeolite; starch encapsulated accord; polyglycerol esters; whitening agent; pearlescent agent; additional enzymes; enzyme stabilizing systems; scavenging agents including fixing agents for anionic dyes, chelant/complexing agents, and mixtures thereof; optical brighteners or fluorescers; polymer including but not limited to soil release polymer and/or soil suspension polymer and/or dye transfer inhibitor polymer; dispersants; vasantifoam agents; non-aqueous solvent; fatty acid; alkoxylated polyaryl/polyalkyl phenol, suds suppressors, e.g., silicone suds suppressors; cationic starches; scum dispersants; fabric shading dyes; colorants; opacifier; antioxidant; hydrotropes such as toluenesulfonates, cumenesulfonates and naphthalenesulfonates; color speckles; colored beads, spheres or extrudates; clay softening agents; anti-bacterial agents; quaternary ammonium compounds; and/or solvent or solvent systems comprising a mixture of solvents. Quaternary ammonium compounds may be particularly present in fabric enhancer compositions, such as fabric softeners, and comprise quaternary ammonium cations that are positively charged polyatomic ions of the structure NR₄₊, where R is an alkyl group or an aryl group. Preferably the composition of the invention comprises a surfactant, or more preferably a surfactant system comprising a combination of surfactants. Preferably the composition of the invention comprises a cellulose polymer, in particular a modified cellulose polymer. Other preferred adjuncts comprise fabric shading agents as described below and/or an additional enzyme as described below, for example selected from lipases, nucleases, amylases, proteases, mannanases, pectate lyases, cellulases, cutinases, and mixtures thereof. The cleaning composition may comprise a cleaning cellulase.

### Surfactant System

The cleaning composition preferably comprises a surfactant system comprising the nonionic surfactant and additional surfactant. Preferably the total amount of surfactant in the composition is from about 1% to about 80%, or from 5% to about 60%, preferably from about 8 to about 50% more preferably from about 12% to about 40%, by weight of the cleaning composition, of a surfactant system. Suitable surfactants may be derived from natural and/or renewable sources.

The surfactant system preferably comprises a non-soap anionic surfactant, more preferably an anionic surfactant selected from the group consisting of linear alkyl benzene sulfonate, alkyl sulfate, alkyl alkoxy sulfate, especially alkyl ethoxy sulfate, paraffin sulfonate and mixtures thereof, preferably comprising linear alkyl benzene sulphonate. The surfactant system may also comprises a surfactant selected from the group consisting of cationic surfactant, amphoteric surfactant, zwitterionic surfactant, and mixtures thereof. The surfactant system preferably comprises an ethoxylated nonionic surfactant.

A preferred surfactant system for the detergent composition of the present invention comprises from 1% to 40%, preferably 6% to 35%, more preferably 8% to 30% weight of the total composition of an anionic surfactant, preferably comprising linear alkyl benzene sulphonate optionally additionally comprising an alkyl alkoxy sulfate surfactant, and the nonionic surfactant. Preferably the weight ratio of anionic surfactant to nonionic surfactant is from 200:1 to 1:2, more preferably from 100:1 to 1:1.

### Nonionic Surfactant

Preferably the nonionic surfactant is present in the composition in an amount from 0.1% to 12%, preferably 0.2% to 10%, most preferably 0.5% to 7%, most preferably from 1 to 3% by weight of the composition. Preferably the nonionic surfactant comprises a fatty alcohol ethoxylate.

Suitable alcohol ethoxylate nonionic surfactants include the condensation products of aliphatic alcohols with ethylene oxide. The alkyl chain of the aliphatic alcohol can either be straight or branched, substituted or unsubstituted. The starting alcohol can be naturally derived, e.g. starting from natural oils, or synthetically derived, e.g. alcohols obtained from for example oxo-, modified oxo- or Fischer-Tropsch processes. Examples of oxo-process derived alcohols include the Lial and Isalchem alcohols ex Sasol company and Lutensol alcohols ex BASF company. Examples of modified-oxo process derived alcohols include the Neodol alcohols ex Shell company. Fischer-Tropsch derived alcohols include Safol alcohols ex Sasol company. The alkoxylate chain of alcohol ethoxylates is made up solely of ethoxylate groups.

Preferably, the fatty alcohol ethoxylate has an average alkyl carbon chain length of between 5 and 30, preferably between 8 and 18, more preferably between 10 and 16, most preferably between 12 and 15.

Preferably, the fatty alcohol ethoxylate has an average degree of ethoxylation of between 0.5 and 20, preferably between 1 and 15, more preferably between 5 and 12, even more preferably between 6 and 10, most preferably between 7 and 8.

Suitable for use herein are the ethoxylated alcohol of the formula R(OC₂H₄)n OH, wherein R is selected from the group consisting of aliphatic hydrocarbon radicals containing from about 8 to about 22 carbon atoms and the average value of n is from about 5 to about 22. In one aspect, particularly useful materials are condensation products of C₉-C₁₆ alcohols with from about 5 to about 20 moles of ethylene oxide per mole of alcohol. In another aspect, particularly useful materials are condensation products of C₁₂-C₁₆ alcohols with from about 6 to about 9 moles of ethylene oxide per mole of alcohol.

Other non-limiting examples of nonionic surfactants may include: C12-C18 alkyl ethoxylates based on modified oxo alcohols, such as, NEODOL® nonionic surfactants from Shell; C12-C15 alkyl ethoxylates based on Fischer Tropsch Oxo alcohols, such as, SAFOL® nonionic surfactants from Sasol; C12-C18 alkyl ethoxylates based on natural or Ziegler alcohols, such as, Surfonic® nonionic surfactants from Huntsman; C14-C22 mid-chain branched alcohols ethoxylates, BAEx, wherein x is from 1 to 30.

Other suitable non-ionic surfactants for use herein include fatty alcohol polyglycol ethers, alkylpolyglucosides and fatty acid glucamides.

### Anionic Surfactant

The non-soap anionic surfactant may comprise a sulphate or a sulphonate anionic surfactant or a mixture thereof, preferably linear alkylbenzene sulphonate, alkyl sulphate, alkoxylated alkyl sulphate or a mixture thereof, more preferably a mixture of linear alkylbenzene sulphonate and alkoxylated alkyl sulphate. Preferably, the ratio of linear alkylbenzene sulphonate to alkoxylated alkyl sulphate more preferably the ratio of linear alkylbenzene sulphonate to ethoxylated alkyl sulphate is from 1:2 to 20:1, preferably from 1.1:1 to 15:1, more preferably from 1.2:1 to 10:1, even more preferably from 1.3:1 to 5:1, most preferably from 1.4:1 to 3:1.

Preferably, the alkoxylated alkyl sulphate is an ethoxylated alkyl sulphate with an average degree of ethoxylation of between 0.5 and 7, preferably between 1 and 5, more preferably between 2 and 4, most preferably about 3. Alternatively, the non-soap surfactant comprises a mixture of one or more alkoxylated alkyl sulphates, preferably ethoxylated alkyl sulphates, and optionally an alkyl sulphate, the mixture having an average degree of ethoxylation of between 0.5 and 7, preferably between 1 and 5, more preferably between 2 and 4, most preferably about 3. The alkyl sulphate and/or alkoxylated alkyl sulphate preferably have an alkyl chain comprising on average between 8 and 18 carbon atoms, preferably between 10 and 16 carbons atoms, most preferably between 12 and 14 carbon atoms. Most preferably the alkoxylated alkyl sulphate is an ethoxylated alkyl chain comprising on average between 12 and 14 carbon atoms in its alkyl chain and has an average degree of ethoxylation of about 3. The alkyl chain of the alkoxylated alkyl sulphate surfactant may be linear or branched or a mixture thereof.

The linear alkylbenzene sulphonate may be a C₁₀-C₁₆ linear alkylbenzene sulphonate or a C₁₁-C₁₄ linear alkylbenzene sulphonate or a mixture thereof.

Exemplary linear alkylbenzene sulphonates are C₁₀-C₁₆ alkyl benzene sulfonic acids, or C₁₁-C₁₄ alkyl benzene sulfonic acids. By ‘linear’, we herein mean the alkyl group is linear. Alkyl benzene sulfonates are well known in the art.

Other suitable anionic detersive surfactants include alkyl ether carboxylates.

Suitable anionic detersive surfactants may be in salt form, suitable counter-ions include sodium, calcium, magnesium, amino alcohols, and any combination thereof. A preferred counter-ion is sodium.

Amphoteric Surfactant

The surfactant system may include amphoteric surfactant, such as amine oxide. Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides include water-soluble amine oxides containing one R1 C8-18 alkyl moiety and 2 R2 and R3 moieties selected from the group consisting of C1-3 alkyl groups and C1-3 hydroxyalkyl groups. Preferably amine oxide is characterized by the formula R1-N(R2)(R3)O wherein R1 is a C8-18 alkyl and R2 and R3 are selected from the group consisting of methyl, ethyl, propyl, isopropyl, 2-hydroxethyl, 2-hydroxypropyl and 3-hydroxypropyl. The linear amine oxide surfactants in particular may include linear C10-C18 alkyl dimethyl amine oxides and linear C8-C12 alkoxy ethyl dihydroxy ethyl amine oxides. Preferred amine oxides include linear C10, linear C10-C12, and linear C12-C14 alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein. The amine oxide may further comprise two moieties, independently selected from a C1-3 alkyl, a C1-3 hydroxyalkyl group, or a polyethylene oxide group containing an average of from about 1 to about 3 ethylene oxide groups. Preferably the two moieties are selected from a C1-3 alkyl, more preferably both are selected as a C1 alkyl.

Zwitterionic Surfactant

Other suitable surfactants include betaines, such as alkyl betaines, alkylamidobetaine, amidazoliniumbetaine, sulfobetaine (INCI Sultaines) as well as the Phosphobetaine and preferably meets formula (I):

R¹—[CO—X(CH₂)ₙ]ₓ—N(R²)(R₃)—(CH₂)ₘ—[CH(OH)—CH₂]_{y}—Y— (I)

wherein
R¹ is a saturated or unsaturated C6-22 alkyl residue, preferably C8-18 alkyl residue, in particular a saturated C10-16 alkyl residue, for example a saturated C12-14 alkyl residue;
X is NH, NR⁴ with C1-4 Alkyl residue R⁴, O or S,
n a number from 1 to 10, preferably 2 to 5, in particular 3,
x 0 or 1, preferably 1,
R², R³ are independently a C1-4 alkyl residue, potentially hydroxy substituted such as a hydroxyethyl, preferably a methyl.
m a number from 1 to 4, in particular 1, 2 or 3,
y 0 or 1 and
Y is COO, SO3, OPO(OR⁵)O or P(O)(OR⁵)O, whereby R⁵ is a hydrogen atom H or a C1-4 alkyl residue.

Preferred betaines are the alkyl betaines of the formula (Ia), the alkyl amido propyl betaine of the formula (Ib), the Sulfo betaines of the formula (Ic) and the Amido sulfobetaine of the formula (Id);

R¹—N⁺(CH₃)₂—CH₂COO⁻ (Ia)

R¹—CO—NH(CH₂)₃—N⁺(CH₃)₂—CH₂COO⁻ (Ib)

R¹—N⁺(CH₃)₂—CH₂CH(OH)CH₂SO₃— (Ic)

R¹—CO—NH—(CH₂)₃—N⁺(CH₃)₂—CH₂CH(OH)CH₂SO₃— (Id) in which R¹¹ as the same meaning as in formula I. Particularly preferred betaines are the Carbobetaine [wherein Y⁻═COO⁻], in particular the Carbobetaine of the formula (Ia) and (Ib), more preferred are the Alkylamidobetaine of the formula (Ib).

Examples of suitable betaines and sulfobetaine are the following [designated in accordance with INCI]: Almondamidopropyl of betaines, Apricotam idopropyl betaines, Avocadamidopropyl of betaines, Babassuamidopropyl of betaines, Behenam idopropyl betaines, Behenyl of betaines, betaines, Canolam idopropyl betaines, Capryl/Capram idopropyl betaines, Carnitine, Cetyl of betaines, Cocamidoethyl of betaines, Cocam idopropyl betaines, Cocam idopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucam idopropyl Hydroxysultaine, Hydrogenated Tallow of betaines, Isostearam idopropyl betaines, Lauram idopropyl betaines, Lauryl of betaines, Lauryl Hydroxysultaine, Lauryl Sultaine, Milkam idopropyl betaines, Minkamidopropyl of betaines, Myristam idopropyl betaines, Myristyl of betaines, Oleam idopropyl betaines, Oleam idopropyl Hydroxysultaine, Oleyl of betaines, Olivamidopropyl of betaines, Palmam idopropyl betaines, Palm itam idopropyl betaines, Palmitoyl Carnitine, Palm Kernelam idopropyl betaines, Polytetrafluoroethylene Acetoxypropyl of betaines, Ricinoleam idopropyl betaines, Sesam idopropyl betaines, Soyam idopropyl betaines, Stearam idopropyl betaines, Stearyl of betaines, Tallowam idopropyl betaines, Tallowam idopropyl Hydroxysultaine, Tallow of betaines, Tallow Dihydroxyethyl of betaines, Undecylenam idopropyl betaines and Wheat Germam idopropyl betaines.

A preferred betaine is, for example, Cocoamidopropylbetaine.

Fatty Acid

The surfactant may comprise a fatty acid, neutralised fatty acid soap or a mixture thereof. Preferably, the liquid laundry detergent composition may comprise less than 10%, preferably less than 8%, more preferably less than 5%, most preferably between 1% and 5% by weight of the liquid laundry detergent composition of fatty acid, neutralised fatty acid soap or a mixture thereof.

The neutralised fatty acid soap may be alkali metal neutralised, amine neutralised or a mixture thereof. The alkali metal may be selected from sodium, potassium, magnesium or a mixture thereof, preferably sodium. The amine is preferably an alkanolamine, preferably selected from monoethanolamine, diethanolamine, triethanolamine or a mixture thereof, more preferably monoethanolamine.

The fatty acid, neutralised fatty acid soap or mixture thereof may be selected from palm kernel fatty acid, coconut fatty acid, rapeseed fatty acid, neutralized palm kernel fatty acid, neutralized coconut fatty acid, neutralized rapeseed fatty acid, or mixture thereof, preferably neutralized palm kernel fatty acid.

Fabric Shading Dye

The composition may comprise a fabric shading agent. Suitable fabric shading agents include dyes, dye-clay conjugates, and pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof. Preferred dyes are selected from azo, anthraquinone, triarylmethane and azine dyes and mixtures thereof, most preferably azo dyes. Preferred small molecule dyes comprise for example, Solvent Violet 13, Acid Violet 50, Acid Violet 51, Basic Violet 4, Direct Violet 9, Direct Violet 99, Direct Violet 66 and mixtures thereof. Most preferred are polymeric dyes wherein the polymer comprises a cellulose polymer, polyvinyl alcohol polymer, polyvinylpyrrolidone polymer or most preferably a polyalkoxylate polymer. Most preferred dyes comprise alkoxylated dyes, such as alkoxylated azo or anthraquinone or triarylmethane dyes. Most preferred dyes comprise alkoxylated azo dyes, particularly alkoxylated thiophenes, for example:

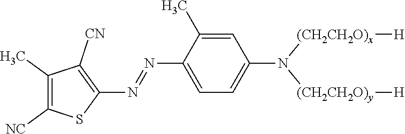

wherein the index values x and y are independently selected from 1 to 10.

Chelant

The composition preferably comprises a complexing agent adjunct. A suitable chelant comprises a phosphonate chelant, for example selected from: 1-hydroxyethane-1,1-diphosphonic acid (HEDP); Diethylene triamine pentamethylene phosphonic acid (DTPMP, CW-Base); 2-phosphonobutane-1,2,4-tricarboxylic acid (PBTC); Amino trimethylene phosphonic acid (ATMP); Ethylenediamine tetramethylene phosphonic acid (EDTMP); Diethylenetriamine pentamethylene phosphonic acid (DTPMP); Aminotrimethylene phosphonic acid (ATMP); salts of the aforementioned materials; and any combination thereof.

Preferred complexing agents comprise an amino acid derivative complexing agent, preferably selected from one or more of the following, in any stereoisomer or mixture of stereoisomer form:

(i) methylglycinediacetic acid and salts thereof (MGDA)

(ii) L-glutamic acid, N,N-diacetic acid and salts thereof (GLDA) and

(iii) L-aspartic acid N,N-diacetic acid and salts thereof (ASDA)

Preferably, the composition comprises from 0.1 wt % to 10 wt % methylglycinediacetic acid and salts thereof (MGDA)

It may be preferred to formulate the chelant/complexing agent in acid form. Alternatively, it may be preferred to formulate the amino acid derivative complexing agent in salt form, especially preferred is the sodium salt form.

Suitable MGDA salts are produced by BASF. Suitable GLDA salts are produced by Akzo Nobel and Showa Denko. Suitable ASDA salts are produced by Mitsubishi Rayon.

Alkoxylated Polyaryl/Polyalkyl Phenol

The compositions of the invention may comprise a polyaryl/polyalkyl phenol adjunt. A suitable alkoxylated polyaryl/polyalkyl phenol has the following structure:

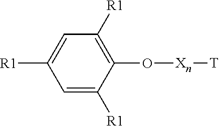

wherein R₁ is selected from linear of branched C₃-C₁₅ alkyl groups and aryl groups, X is selected from ethoxy or propoxy groups, n is from 2 to 70, T is selected from H, SO₃⁻, COO⁻ and PO₃²⁻

The alkoxylated polyaryl or alkoxylated polyalkyl phenol is preferably selected from groups (i) to (iv):

### (i) Uncharged Alkoxylated Tristyrylphenols of the Following Structure:

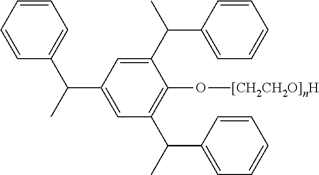

wherein n is selected from 2 to 70, more preferably n is selected from 10 to 54, most preferably n=16 or 20.

### (ii) Anionic Alkoxylated Tristyrylphenols of the Following Structure

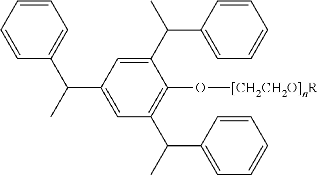

wherein R is selected from SO₃⁻, COO⁻ and PO₃²⁻, preferably selected from SO₃⁻ and COO⁻,
wherein n is selected from 2 to 54.
(iii) Uncharged Alkoxylated Tri(n-Butyl)Phenols of the Following Structure:

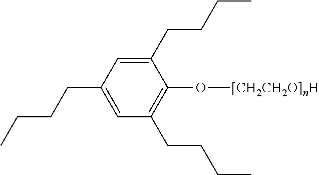

wherein n is selected from 2 to 50

### (iv) Anionic Alkoxylated Tri(n-Butyl)Phenols of the Following Structure:

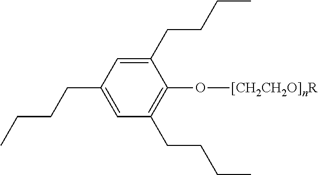

wherein R is selected from SO₃⁻, COO⁻ and PO₃²⁻, preferably selected from SO₃⁻ and COO⁻, wherein n is selected from 6 to 50.

Such compounds are available from industrial suppliers, for example Solvay under the Soprophor trade name, from Clariant under the Emulsogen trade name, Aoki Oil Industrial Co. under the Blaunon trade name, from Stepan under the Makon trade name, and from TOTO Chemical Industry Co. under the Sorpol trade name. Specific examples of suitable compounds are Emulsogen® TS160, Hostapal® BV conc., Sapogenat® T110 or Sapogenat® T139, all from Clariant.

The alkoxylated polyaryl/polyalkyl phenol may be present at levels of 0.5-20 wt %, preferably 1-15 wt %, most preferably 3-10 wt %.

### Additional Enzymes

Preferably the composition of the invention comprises additional enzymes, for example selected from lipases, proteases, nucleases, pectate lyases, cellulases, cutinases, mannanases, galactanases and mixtures thereof. The cleaning compositions preferably comprise one or more additional enzymes from the group selected from nucleases. The cleaning compositions preferably comprises one or more additional enzymes selected from the group amylases, lipases, proteases, pectate lyases, cellulases, cutinases, and mixtures thereof. Preferably, the cleaning compositions comprises one or more additional enzymes selected from amylases and proteases and mixtures thereof. Preferably the cleaning compositions comprise one or more additional enzymes selected from lipases. The compositions may also comprise hemicellulases, peroxidases, xylanases, pectinases, keratinases, reductases, oxidases, phenoloxidases, lipoxygenases, ligninases, pullulanases, tannases, pentosanases, malanases, 1-glucanases, arabinosidases, hyaluronidase, chondroitinase, laccase and mixtures thereof. When present in the composition, the aforementioned additional enzymes may be present at levels from about 0.00001% to about 2%, from about 0.0001% to about 1% or even from about 0.001% to about 0.5% enzyme protein by weight of the composition. Preferably the or each additional enzyme is present in the laundering aqueous wash liquor in an amount of from 0.01 ppm to 1000 ppm of the active enzyme protein, or from 0.05 or from 0.1 ppm to 750 or 500 ppm.

### Nucleases

Preferably the composition additionally comprises a nuclease enzyme. The nuclease enzyme is an enzyme capable of cleaving the phosphodiester bonds between the nucleotide sub-units of nucleic acids. Suitable nuclease enzymes may be deoxyribonuclease or ribonuclease enzyme or a functional fragment thereof. By functional fragment or part is meant the portion of the nuclease enzyme that catalyzes the cleavage of phosphodiester linkages in the DNA backbone and so is a region of said nuclease protein that retains catalytic activity. Thus it includes truncated, but functional versions, of the enzyme and/or variants and/or derivatives and/or homologues whose functionality is maintained.

Preferably the nuclease enzyme is a deoxyribonuclease, preferably selected from any of the classes E.C. 3.1.21.x, where x=1, 2, 3, 4, 5, 6, 7, 8 or 9, E.C. 3.1.22.y where y=1, 2, 4 or 5, E.C. 3.1.30.z where z=1 or 2, E.C. 3.1.31.1 and mixtures thereof. Nuclease enzymes from class E.C. 3.1.21.x and especially where x=1 are particularly preferred. Nucleases in class E.C. 3.1.22.y cleave at the 5′ hydroxyl to liberate 3′ phosphomonoesters. Enzymes in class E.C. 3.1.30.z may be preferred as they act on both DNA and RNA and liberate 5′-phosphomonoesters. Suitable examples from class E.C. 3.1.31.2 are described in US2012/0135498A, such as SEQ ID NO:3 therein. Such enzymes are commercially available as DENARASE® enzyme from c-LECTA. Nuclease enzymes from class E.C. 3.1.31.1 produce 3′phosphomonoesters.

Preferably, the nuclease enzyme comprises a microbial enzyme. The nuclease enzyme may be fungal or bacterial in origin. Bacterial nucleases may be most preferred. Fungal nucleases may be most preferred.

The microbial nuclease is obtainable from Bacillus, such as a Bacillus licheniformis or Bacillus subtilis bacterial nucleases. A preferred nuclease is obtainable from Bacillus licheniformis, preferably from strain EI-34-6. A preferred deoxyribonuclease is a variant of Bacillus licheniformis, from strain EI-34-6 nucB deoxyribonuclease defined in SEQ ID NO:5 herein, or variant thereof, for example having at least 70% or 75% or 80% or 85% or 90% or 95%, 96%, 97%, 98%, 99% or 100% identical thereto. Other suitable nucleases are defined in SEQ ID NO: 6 herein, or variant thereof, for example having at least 70% or 75% or 80% or 85% or 90% or 95%, 96%, 97%, 98%, 99% or 100% identical thereto. Other suitable nucleases are defined in SEQ ID NO: 7 herein, or variant thereof, for example having at least 70% or 75% or 80% or 85% or 90% or 95%, 96%, 97%, 98%, 99% or 100% identical thereto.

A fungal nuclease is obtainable from Aspergillus, for example Aspergillus oryzae. A preferred nuclease is obtainable from Aspergillus oryzae defined in SEQ ID NO:8 herein, or variant thereof, for example having at least 60% or 70% or75% or 80% or 85% or 90% or 95%, 96%, 97%, 98%, 99% or 100% identical thereto.

Another suitable fungal nuclease is obtainable from Trichoderma, for example Trichoderma harzianum. A preferred nuclease is obtainable from Trichoderma harzianum defined in SEQ ID NO:9 herein, or variant thereof, for example having at least 60% or 70% or 75% or 80% or 85% or 90% or 95%, 96%, 97%, 98%, 99% or 100% identical thereto.

Other fungal nucleases include those encoded by the DNA sequences of Aspergillus oryzae RIB40, Aspergillus oryzae 3.042, Aspergillus flavus NRRL3357, Aspergillus parasiticus SU-1, Aspergillus nomius NRRL13137, Trichoderma reesei QM6a, Trichoderma virens Gv29-8, Oidiodendron maius Zn, Metarhizium guizhouense ARSEF 977, Metarhizium majus ARSEF 297, Metarhizium robertsii ARSEF 23, Metarhizium acridum CQMa 102, Metarhizium brunneum ARSEF 3297, Metarhizium anisopliae, Colletotrichum fioriniae PJ7, Colletotrichum sublineola, Trichoderma atroviride IMI 206040, Tolypocladium ophioglossoides CBS 100239, Beauveria bassiana ARSEF 2860, Colletotrichum higginsianum, Hirsutella minnesotensis 3608, Scedosporium apiospermum, Phaeomoniella chlamydospora, Fusarium verticillioides 7600, Fusarium oxysporum f. sp. cubense race 4, Colletotrichum graminicola M1.001, Fusarium oxysporum FOSC 3-a, Fusarium avenaceum, Fusarium langsethiae, Grosmannia clavigera kw1407, Claviceps purpurea 20.1, Verticillium longisporum, Fusarium oxysporum f. sp. cubense race 1, Magnaporthe oryzae 70-15, Beauveria bassiana D1-5, Fusarium pseudograminearum CS3096, Neonectria ditissima, Magnaporthiopsis poae ATCC 64411, Cordyceps militaris CM01, Marssonina brunnea f. sp. ‘multigermtubi’ MB_m1, Diaporthe ampelina, Metarhizium album ARSEF 1941, Colletotrichum gloeosporioides Nara gc5, Madurella mycetomatis, Metarhizium brunneum ARSEF 3297, Verticillium alfalfae VaMs.102, Gaeumannomyces graminis var. tritici R3-111a-1, Nectria haematococca mpVI 77-13-4, Verticillium longisporum, Verticillium dahliae VdLs.17, Torrubiella hemipterigena, Verticillium longisporum, Verticillium dahliae VdLs.17, Botrytis cinerea B05.10, Chaetomium globosum CBS 148.51, Metarhizium anisopliae, Stemphylium lycopersici, Sclerotinia borealis F-4157, Metarhizium robertsii ARSEF 23, Myceliophthora thermophila ATCC 42464, Phaeosphaeria nodorum SN15, Phialophora attae, Ustilaginoidea virens, Diplodia seriata, Ophiostoma piceae UAMH 11346, Pseudogymnoascus pannorum VKM F-4515 (FW-2607), Bipolaris oryzae ATCC 44560, Metarhizium guizhouense ARSEF 977, Chaetomium thermophilum var. thermophilum DSM 1495, Pestalotiopsis fici W106-1, Bipolaris zeicola 26-R-13, Setosphaeria turcica Et28A, Arthroderma otae CBS 113480 and Pyrenophora tritici-repentis Pt-1C-BFP.

Preferably the nuclease is an isolated nuclease.

Preferably the nuclease enzyme is present in the aqueous wash liquor in an amount of from 0.01 ppm to 1000 ppm of the nuclease enzyme, or from 0.05 or from 0.1 ppm to 750 or 500 ppm.

### Acetylglucosaminidases.

Preferably the composition comprises an acetylglucosaminidase enzyme, preferably a 3-N-acetylglucosaminidase enzyme from E.C. 3.2.1.52, preferably an enzyme having at least 70%, or at least 75% or at least 80% or at least 85% or at least 90% or at least 95% or at least 96% or at least 97% or at least 98% or at least 99% or at least or 100% identity to SEQ ID NO:10.

### Mannanases

Preferably the composition comprises a mannanase enzyme. The term “mannanase” means a polypeptide having mannan endo-1,4-beta-mannosidase activity (EC 3.2.1.78) from the glycoside hydrolase family 26 that catalyzes the hydrolysis of 1,4-3-D-mannosidic linkages in mannans, galactomannans and glucomannans. Alternative names of mannan endo-1,4-beta-mannosidase are 1,4-3-D-mannan mannanohydrolase; endo-1,4-3-mannanase; endo-β-1,4-mannase; β-mannanase B; β-1,4-mannan 4-mannanohydrolase; endo-3-mannanase; and β-D-mannanase. Preferred mannanases are members of the glycoside hydrolase family 26.

For purposes of the present disclosure, mannanase activity may be determined using the Reducing End Assay as described in the experimental section of WO 2015040159. Suitable examples from class EC 3.2.1.78 are described in WO 2015040159, such as the mature polypeptide SEQ ID NO: 16described therein.

Preferred mannanases are variants having at least 60%, at least 65%, at least 70%, at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the mature polypeptide SEQ ID NO: 11 from Ascobolus stictoideus;

Preferred mannanases are variants having at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the mature polypeptide SEQ ID NO: 12 from Chaetomium virescens.

Preferred mannanases are variants having at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the mature polypeptide SEQ ID NO: 13 from Preussia aemulans.

Preferred mannanases are variants having at least at least 65%, at least 66%, at least 67%, at least 68%, at least 69%, at least 70%, at least 71%, at least 72%, at least 73%, at least 74%, at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the mature polypeptide SEQ ID NO: 14 from Yunnania penicillata.

Preferred mannanases are variants having at least at least 75%, at least 76%, at least 77%, at least 78%, at least 79%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99% or 100% sequence identity to the mature polypeptide SEQ ID NO: 15 from Myrothecium roridum. Preferably the mannanase is an isolated mannanase.

Preferably the mannanase enzyme is present in the cleaning compositions in an amount from 0.001 to 1 wt % based on active protein in the composition, or from 0.005 to 0.5 wt % or from 0.01 to 0.25 wt %. Preferably the mannanase enzyme is present in the aqueous wash liquor in an amount of from 0.01 ppm to 1000 ppm of the mannanase enzyme, or from 0.05 or from 0.1 ppm to 750 or 500 ppm. The compositions of the invention comprising both galactanase and mannanase may be particularly effective against sticky soils and for improved cleaning. It is believed the two enzymes function together in a complementary way.

Galactanase Enzyme

The endo-beta-1,6-galactanase enzyme is an extracellular polymer-degrading enzyme. The term “endo-beta-1,6-galactanase” or “a polypeptide having endo-beta-1,6-galactanase activity” means a endo-beta-1,6-galactanase activity (EC 3.2.1.164) that catalyzes the hydrolytic cleavage of 1,6-3-D-galactooligosaccharides with a degree of polymerization (DP) higher than 3, and their acidic derivatives with 4-O-methylglucosyluronate or glucosyluronate groups at the non-reducing terminals.

Preferably the galactanase enzyme is selected from Glycoside Hydrolase (GH) Family 30. Preferably, the endo-beta-1,6-galactanase comprises a microbial enzyme. The endo-beta-1,6-galactanase may be fungal or bacterial in origin. Bacterial endo-beta-1,6-galactanase may be most preferred. Fungal endo-beta-1,6-galactanase may be most preferred.

A bacterial endo-beta-1,6-galactanase is obtainable from Streptomyces, for example Streptomyces davawensis. A preferred endo-beta-1,6-galactanase is obtainable from Streptomyces davawensis JCM 4913 defined in SEQ ID NO: 16 herein, or a variant thereof, for example having at least 40% or 50% or 60% or 70% or 75% or 80% or 85% or 90% or 95%, 96%, 97%, 98%, 99% or 100% identity thereto.

Other bacterial endo-beta-1,6-galactanase include those encoded by the DNA sequences of Streptomyces avermitilis MA-4680 defined in SEQ ID NO: 3 herein, or a variant thereof, for example having at least 40% or 50% or 60% or 70% or 75% or 80% or 85% or 90% or 95%, 96%, 97%, 98%, 99% or 100% identity thereto.

A fungal endo-beta-1,6-galactanase is obtainable from Trichoderma, for example Trichoderma harzianum. A preferred endo-beta-1,6-galactanase is obtainable from Trichoderma harzianum defined in SEQ ID NO: 4 herein, or a variant thereof, for example having at least 40% or 50% or 60% or 70% or 75% or 80% or 85% or 90% or 95%, 96%, 97%, 98%, 99% or 100% identical thereto.

Other fungal endo-beta-1,6-galactanases include those encoded by the DNA sequences of Ceratocystis fimbriata f. sp. Platani, Muscodor strobelii WG-2009a, Oculimacula yallundae, Trichoderma viride GD36A, Thermomyces stellatus, Myceliophthora thermophilia.

Preferably the galactanase has an amino acid sequence having at least 60%, or at least 80%, or at least 90% or at least 95% identity with the amino acid sequence shown in SEQ ID NO:16, SEQ ID NO:3 or SEQ ID NO:4.

Preferably the galactanase is an isolated galactanase.

Preferably the galactanase enzyme is present in a the laundering aqueous solution in an amount of from 0.01 ppm to 1000 ppm of the galactanase enzyme, or from 0.05 or from 0.1 ppm to 750 or 500 ppm.

The galactanases may also give rise to biofilm-disrupting effects.

### Glycosyl Hydrolases

The composition may comprise a glycosyl hydrolase selected from GH family 39 and GH family 114 and mixtures thereof, for example as described in co-pending applications having applicants reference numbers CM4645FM and CM4646 FM, respectively.

### Proteases.

Preferably the composition comprises one or more proteases. Suitable proteases include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:

(a) subtilisins (EC 3.4.21.62), especially those derived from Bacillus, such as Bacillus sp., B. lentus, B. alkalophilus, B. subtilis, B. amyloliquefaciens, B. pumilus, B. gibsonii, and B. akibaii described in WO2004067737, WO2015091989, WO2015091990, WO2015024739, WO2015143360, U.S. Pat. No. 6,312,936 B1, U.S. Pat. Nos. 5,679,630, 4,760,025, DE102006022216A1, DE102006022224A1, WO2015089447, WO2015089441, WO2016066756, WO2016066757, WO2016069557, WO2016069563, WO2016069569.

(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.

(c) metalloproteases, especially those derived from Bacillus amyloliquefaciens decribed in WO07/044993A2; from Bacillus, Brevibacillus, Thermoactinomyces, Geobacillus, Paenibacillus, Lysinibacillus or Streptomyces spp. Described in WO2014194032, WO2014194054 and WO2014194117; from Kribella alluminosa described in WO2015193488; and from Streptomyces and Lysobacter described in WO2016075078.

(d) Protease having at least 90% identity to the subtilase from Bacillus sp. TY145, NCIMB 40339, described in WO92/17577 (Novozymes A/S), including the variants of this Bacillus sp TY145 subtilase described in WO2015024739, and WO2016066757.

Especially preferred proteases for the detergent of the invention are polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN' numbering system and amino acid abbreviations as illustrated in WO00/37627, which is incorporated herein by reference:V68A, N76D, N87S, S99D, S99SD, S99A, S101G, S101M, S103A, V104N/I, G118V, G118R, S128L, P129Q, S130A, Y167A, R170S, A194P, V205I, Q206L/D/E, Y209W and/or M222S.

Most preferably the protease is selected from the group comprising the below mutations (BPN' numbering system) versus either the PB92 wild-type (SEQ ID NO:2 in WO 08/010925) or the subtilisin 309 wild-type (sequence as per PB92 backbone, except comprising a natural variation of N87S).

(i) G118V+S128L+P129Q+S130A

(ii) S101M+G118V+S128L+P129Q+S130A

(iii) N76D+N87R+G118R+S128L+P129Q+S130A+S188D+N248R

(iv) N76D+N87R+G118R+S128L+P129Q+S130A+S188D+V244R

(v) N76D+N87R+G118R+S128L+P129Q+S130A

(vi) V68A+N87S+S101G+V104N

(vii) S99AD

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase®, Coronase®, Blaze®, Blaze Ultra® and Esperase® by Novozymes A/S (Denmark); those sold under the tradename Maxatase®, Maxacal®, Maxapem®, Properase®, Purafect®, Purafect Prime®, Purafect Ox®, FN3®, FN4®, Excellase®, Ultimase® and Purafect OXP® by Dupont; those sold under the tradename Opticlean® and Optimase® by Solvay Enzymes; and those available from Henkel/Kemira, namely BLAP (sequence shown in FIG. 29 of U.S. Pat. No. 5,352,604 with the following mutations S99D+S101R+S103A+V104I+G159S, hereinafter referred to as BLAP), BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D); and KAP (Bacillus alkalophilus subtilisin with mutations A230V+S256G+S259N) from Kao.

Especially preferred for use herein in combination with the variant protease of the invention are commercial proteases selected from the group consisting of Properase®, Blaze®, Ultimase®, Everlase®, Savinase®, Excellase®, Blaze Ultra®, BLAP and BLAP variants.

### Lipases

Preferably the composition comprises one or more lipases, including “first cycle lipases” such as those described in U.S. Pat. No. 6,939,702 B1 and US PA 2009/0217464. Preferred lipases are first-wash lipases. In one embodiment of the invention the composition comprises a first wash lipase. First wash lipases includes a lipase which is a polypeptide having an amino acid sequence which: (a) has at least 90% identity with the wild-type lipase derived from Humicola lanuginosa strain DSM 4109; (b) compared to said wild-type lipase, comprises a substitution of an electrically neutral or negatively charged amino acid at the surface of the three-dimensional structure within 15A of E1 or Q249 with a positively charged amino acid; and (c) comprises a peptide addition at the C-terminal; and/or (d) comprises a peptide addition at the N-terminal and/or (e) meets the following limitations: i) comprises a negative amino acid in position E210 of said wild-type lipase; ii) comprises a negatively charged amino acid in the region corresponding to positions 90-101 of said wild-type lipase; and iii) comprises a neutral or negative amino acid at a position corresponding to N94 or said wild-type lipase and/or has a negative or neutral net electric charge in the region corresponding to positions 90-101 of said wild-type lipase. Preferred are variants of the wild-type lipase from Thermomyces lanuginosus comprising one or more of the T231R and N233R mutations. The wild-type sequence is the 269 amino acids (amino acids 23-291) of the Swissprot accession number Swiss-Prot 059952 (derived from Thermomyces lanuginosus (Humicola lanuginosa)). Preferred lipases include those sold under the tradenames Lipex® and Lipolex® and Lipoclean®. Other suitable lipases include those described in European Patent Application No. 12001034.3 or EP2623586.

### Endoglucanases

Other preferred enzymes include microbial-derived endoglucanases exhibiting endo-beta-1,4-glucanase activity (E.C. 3.2.1.4), including a bacterial polypeptide endogenous to a member of the genus Bacillus which has a sequence of at least 90%, 94%, 97% and even 99% identity to the amino acid sequence SEQ ID NO:2 in U.S. Pat. No. 7,141,403B2) and mixtures thereof. Suitable endoglucanases are sold under the tradenames Celluclean® and Whitezyme® (Novozymes A/S, Bagsvaerd, Denmark).

### Pectate Lyases

Other preferred enzymes include pectate lyases sold under the tradenames Pectawash®, Pectaway®, Xpect® and mannanases sold under the tradenames Mannaway® (all from Novozymes A/S, Bagsvaerd, Denmark), and Purabrite® (Genencor International Inc., Palo Alto, Calif.).

### Cleaning Cellulase

The cleaning composition described herein may additionally comprise a cleaning cellulase. The cellulase may be an endoglucanase. The cellulase may have endo beta 1,4-glucanase activity and a structure which does not comprise a class A Carbohydrate Binding Module (CBM). A class A CBM is defined according to A. B. Boraston et al. Biochemical Journal 2004, Volume 382 (part 3) pages 769-781. In particular, the cellulase does not comprise a class A CBM from families 1, 2a, 3, 5 and 10.

The cellulase may be a glycosyl hydrolase having enzymatic activity towards amorphous cellulose substrates, wherein the glycosyl hydrolase is selected from GH families 5, 7, 12, 16, 44 or 74. Preferably, the cellulase is a glycosyl hydrolase selected from GH family 5. A preferred cellulase is Celluclean, supplied by Novozymes. This preferred cellulase is described in more detail in WO2002/099091. The glycosyl hydrolase (GH) family definition is described in more detail in Biochem J. 1991, v 280, 309-316. Another preferred cellulase is a glycosyl hydrolase having enzymatic activity towards both xyloglucan and amorphous cellulose substrates, wherein the glycosyl hydrolase is selected from GH families 5, 12, 44 or 74. Preferably, the glycosyl hydrolase selected from GH family 44.

For purposes of the present invention, the degree of identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends in Genetics 16: 276-277), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows: (Identical Residues×100)/(Length of Alignment−Total Number of Gaps in Alignment).

Suitable cleaning cellulase glycosyl hydrolases are selected from the group consisting of: GH family 44 glycosyl hydrolases from Paenibacillus polyxyma (wild-type) such as XYG1006 described in WO 01/062903 or are variants thereof; GH family 12 glycosyl hydrolases from Bacillus licheniformis (wild-type) such as Seq. No. ID: 1 described in WO 99/02663 or are variants thereof; GH family 5 glycosyl hydrolases from Bacillus agaradhaerens (wild type) or variants thereof; GH family 5 glycosyl hydrolases from Paenibacillus (wild type) such as XYG1034 and XYG 1022described in WO 01/064853 or variants thereof; GH family 74 glycosyl hydrolases from Jonesia sp. (wild type) such as XYG1020 described in WO 2002/077242 or variants thereof; and GH family 74 glycosyl hydrolases from Trichoderma Reesei (wild type), such as the enzyme described in more detail in Sequence ID no. 2 of WO03/089598, or variants thereof.

Preferred glycosyl hydrolases are selected from the group consisting of: GH family 44 glycosyl hydrolases from Paenibacillus polyxyma (wild-type) such as XYG1006 or are variants thereof.

Typically, the cellulase modifies the fabric surface during the laundering process so as to improve the removal of soils adhered to the fabric after the laundering process during wearing and usage of the fabric, in subsequent wash cycles. Preferably, the cellulase modifies the fabric surface during the laundering process so as to improve the removal of soils adhered to the fabric after the laundering process during wearing and usage of the fabric, in the subsequent two, or even three wash cycles.

Typically, the cellulase is used at a concentration of 0.005 ppm to 1.0 ppm in the aqueous wash liquor during the first laundering process. Preferably, the cellulase is used at a concentration of 0.02 ppm to 0.5 ppm in the aqueous wash liquor during the first laundering process.

### Polymers

The detergent composition may comprise one or more polymers for example for cleaning and/or care. Examples are optionally modified carboxymethylcellulose, poly (ethylene glycol), poly(vinyl alcohol), polycarboxylates such as polyacrylates, maleic/acrylic acid copolymers and lauryl methacrylate/acrylic acid co-polymers and carboxylate polymers.

Suitable carboxylate polymers include maleate/acrylate random copolymer or polyacrylate homopolymer. The carboxylate polymer may be a polyacrylate homopolymer having a molecular weight of from 4,000 Da to 9,000 Da, or from 6,000 Da to 9,000 Da. Other suitable carboxylate polymers are co-polymers of maleic acid and acrylic acid, and may have a molecular weight in the range of from 4,000 Da to 90,000 Da.

Other suitable carboxylate polymers are co-polymers comprising: (i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers represented by formulas (I) and (II):

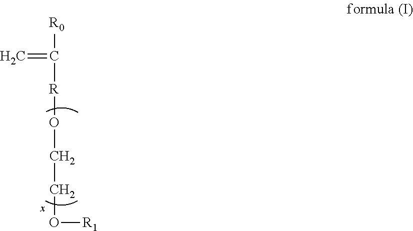

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C1 to C20 organic group;

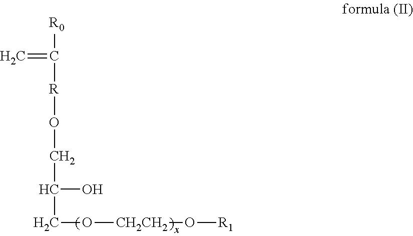

in formula (II), R0 represents a hydrogen atom or CH3 group, R represents a CH2 group, CH2CH2 group or single bond, X represents a number 0-5, and R1 is a hydrogen atom or C1 to C20 organic group. It may be preferred that the polymer has a weight average molecular weight of at least 50 kDa, or even at least 70 kDa.

The composition may comprise one or more amphiphilic cleaning polymers such as the compound having the following general structure: bis((C₂H₅O)(C₂H₄O)n)(CH₃)—N⁺—CₓH₂ₓ—N⁺—(CH₃)-bis((C₂HsO)(C₂H₄O)n), wherein n=from 20 to 30, and x=from 3 to 8, or sulphated or sulphonated variants thereof. In one aspect, this polymer is sulphated or sulphonated to provide a zwitterionic soil suspension polymer.

The composition preferably comprises amphiphilic alkoxylated grease cleaning polymers which have balanced hydrophilic and properties such that they remove grease particles from fabrics and surfaces. Preferred amphiphilic alkoxylated grease cleaning polymers comprise a core structure and a plurality of alkoxylate groups attached to that core structure. These may comprise alkoxylated polyalkylenimines, preferably having an inner polyethylene oxide block and an outer polypropylene oxide block. Typically these may be incorporated into the compositions of the invention in amounts of from 0.005 to 10 wt %, generally from 0.5 to 8 wt %.

Alkoxylated polycarboxylates such as those prepared from polyacrylates are useful herein to provide additional grease removal performance. Such materials are described in WO 91/08281 and PCT 90/01815. Chemically, these materials comprise polyacrylates having one ethoxy side-chain per every 7-8 acrylate units. The side-chains are of the formula —(CH₂CH₂O)ₘ(CH₂)ₙCH₃ wherein m is 2-3 and n is 6-12. The side-chains are ester-linked to the polyacrylate “backbone” to provide a “comb” polymer type structure. The molecular weight can vary, but is typically in the range of about 2000 to about 50,000. Such alkoxylated polycarboxylates can comprise from about 0.05% to about 10%, by weight, of the compositions herein.

Preferably the composition comprises one or more carboxylate polymer, such as a maleate/acrylate random copolymer or polyacrylate homopolymer. In one aspect, the carboxylate polymer is a polyacrylate homopolymer having a molecular weight of from 4,000 Da to 9,000 Da, or from 6,000 Da to 9,000 Da. Typically these are incorporated into the compositions of the invention in amounts from 0.005 to 10 wt %, or from 0.05 to 8 wt %.

The composition preferably comprises a cationically-modified polysaccharide polymer. Preferably, the cationic polysaccharide polymer is selected from cationically modified hydroxyethyl cellulose, cationically modified hydroxypropyl cellulose, cationically and hydrophobically modified hydroxyethyl cellulose, cationically and hydrophobically modified hydroxypropyl cellulose, or a mixture thereof, more preferably cationically modified hydroxyethyl cellulose, cationically and hydrophobically modified hydroxyethyl cellulose, or a mixture thereof.

Soil Release Polymer:

The composition may comprise a soil release polymer. A suitable soil release polymer has a structure as defined by one of the following structures (I), (II) or (III):

—[(OCHR¹—CHR²)ₐ—O—OC—Ar—CO-]_{d} (I)

—[(OCHR³—CHR⁴)_{b}—O—OC-sAr-CO-]ₑ (II)

—[(OCHR⁵—CHR⁶)_{c}—OR⁷]_{f} (III)

wherein:
a, b and c are from 1 to 200;
d, e and f are from 1 to 50;
Ar is a 1,4-substituted phenylene;
sAr is 1,3-substituted phenylene substituted in position 5 with SO₃Me;
Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;
R¹, R², R³, R⁴, R⁵ and R⁶ are independently selected from H or C₁-C₁₈ n- or iso-alkyl; and
R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are sold by Clariant under the TexCare® series of polymers, e.g. TexCare® SRA100, SRA300, SRN100, SRN170, SRN240, SRN260, SRN300 and SRN325 and TexCare® SRA300, SRN240 and SRA 300 being particularly preferred. Other suitable soil release polymers are sold by Solvay under the Repel-o-Tex® series of polymers, e.g. Repel-o-Tex® SF2, SRP6 and Repel-o-Tex® Crystal. Preferably the composition comprises one or more soil release polymers. Other suitable soil release polymers are Marloquest polymers, such as Marloquest SL supplied by Sasol.

Anti-Redeposition Polymer:

Suitable anti-redeposition polymers include polyethylene glycol polymers and/or polyethyleneimine polymers.

Suitable polyethylene glycol polymers include random graft co-polymers comprising: (i) hydrophilic backbone comprising polyethylene glycol; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide units can be less than 1, or less than 0.8, the average number of graft sites per ethylene oxide units can be in the range of from 0.5 to 0.9, or the average number of graft sites per ethylene oxide units can be in the range of from 0.1 to 0.5, or from 0.2 to 0.4. A suitable polyethylene glycol polymer is Sokalan HP22. Suitable polyethylene glycol polymers are described in WO08/007320.

Typically these polymers when present are each incorporated into the compositions of the invention in amounts from 0.005 to 10 wt %, more usually from 0.05 to 8 wt %.

Cellulosic Polymer:

Preferably the composition comprises a cellulosic polymer. Suitable cellulosic polymers are selected from alkyl cellulose, alkyl alkoxyalkyl cellulose, carboxyalkyl cellulose, alkyl carboxyalkyl cellulose, sulphoalkyl cellulose, more preferably selected from carboxymethyl cellulose, methyl cellulose, methyl hydroxyethyl cellulose, methyl carboxymethyl cellulose, and mixures thereof.

Preferred carboxymethyl celluloses have a degree of carboxymethyl substitution from 0.5 to 0.9 and a molecular weight from 100,000 Da to 300,000 Da.

Suitable carboxymethyl celluloses have a degree of substitution greater than 0.65 and a degree of blockiness greater than 0.45, e.g. as described in WO09/154933.

Care Polymers:

Suitable care polymers include cellulosic polymers that are cationically modified and/or hydrophobically modified. Such modified cellulosic polymers can provide anti-abrasion benefits and dye lock benefits to fabric during the laundering cycle. Suitable cellulosic polymers include cationically modified hydroxyethyl cellulose. Suitable care polymers also include guar polymers that are cationically and/or hydrophobically modified. Other suitable care polymers include dye lock polymers, for example the condensation oligomer produced by the condensation of imidazole and epichlorhydrin, preferably in ratio of 1:4:1. A suitable commercially available dye lock polymer is Polyquart® FDI (Cognis).

Other suitable care polymers include amino-silicone, which can provide fabric feel benefits and fabric shape retention benefits.

Alkoxylated Polyalkyleneimine:

The composition may comprise an alkoxylated polyalkyleneimine, wherein said alkoxylated polyalkyleneimine has a polyalkyleneimine core with one or more side chains bonded to at least one nitrogen atom in the polyalkyleneimine core, wherein said alkoxylated polyalkyleneimine has an empirical formula (I) of (PEI)ₐ-(EO)_{b}—R₁, wherein a is the average number-average molecular weight (MW_{PEI}) of the polyalkyleneimine core of the alkoxylated polyalkyleneimine and is in the range of from 100 to 100,000 Daltons, wherein b is the average degree of ethoxylation in said one or more side chains of the alkoxylated polyalkyleneimine and is in the range of from 5 to 40, and wherein R₁ is independently selected from the group consisting of hydrogen, C₁-C₄ alkyls, and combinations thereof.

The composition may comprise an alkoxylated polyalkyleneimine, wherein said alkoxylated polyalkyleneimine has a polyalkyleneimine core with one or more side chains bonded to at least one nitrogen atom in the polyalkyleneimine core, wherein the alkoxylated polyalkyleneimine has an empirical formula (II) of (PEI)ₒ-(EO)ₘ(PO)ₙ—R₂ or (PEI)ₒ-(PO)ₙ(EO)ₘ—R₂, wherein o is the average number-average molecular weight (MW_{PEI}) of the polyalkyleneimine core of the alkoxylated polyalkyleneimine and is in the range of from 100 to 100,000 Daltons, wherein m is the average degree of ethoxylation in said one or more side chains of the alkoxylated polyalkyleneimine which ranges from 10 to 50, wherein n is the average degree of propoxylation in said one or more side chains of the alkoxylated polyalkyleneimine which ranges from 1 to 50, and wherein R₂ is independently selected from the group consisting of hydrogen, C₁-C₄ alkyls, and combinations thereof.

### Dye Control Agent

The cleaning composition may comprise a dye control agent typically present in the composition at a level of from about 0.02% to about 1%, or from about 0.05% to about 0.5%, by weight of the cleaning composition.

The dye control agent may be selected from the group consisting of: (i) a sulfonated phenol/formaldehyde polymer; (ii) a urea derivative; (iii) polymers of ethylenically unsaturated monomers, where the polymers are molecularly imprinted with dye; (iv) fibers consisting of water-insoluble polyamide, wherein the fibers have an average diameter of not more than about 2 am; (v) a polymer obtainable from polymerizing benzoxazine monomer compounds; and (vi) combinations thereof. These dye control agents are described in more detail below.

(i) Sulfonated Phenol/Formaldehyde Polymer

The dye control agent may comprise a sulfonated phenol/formaldehyde polymer. The sulfonated phenol/formaldehyde polymer may be selected from the product of the condensation of formaldehyde with phenol, cresols, xylenols, nonyl phenol, octyl phenol, butylphenol, phenylphenol, 2,2-bis-4-hydroxyphenylpropane, anisole, resorcinol, bisphenol A, 4,4′-, 2,2′- or 4,2′-dihydroxydiphenyl ether, phenolsulfonic acid, anisole sulfonic acid, dioxydiphenylsulfone, 4-hydroxydiphenylsulfone, naphthol or naphtholsulfonic acid. Suitable examples include Suparex® O.IN (M1), Nylofixan® P (M2), Nylofixan® PM (M3), and Nylofixan® HF (M4) (all supplied by Archroma, Reinach, Switzerland).

(ii) Urea Derivative

The dye control agent may comprise a urea derivative. The urea derivative may have a structure according to Formula I,

(A)ₖAr—NH—C(O)—NH—Ar(A)ₗ-NH[—C(O)—NH-L-NH—C(O)—NH—Ar(A)ₘNH]ₙ—C(O)—NH—Ar(A)ₖ Formula I

in which

Ar denotes an aromatic group, a stilbene group, or a linear, branched, or cyclic, saturated or once or several times ethylenically unsaturated hydrocarbon group with 1 to 12 carbon atoms;

L denotes an arylene or stilbene group;

A denotes —SO₃M or —CO₂M;

M denotes H or an alkali metal atom;

k and m irrespective of each other denote 0, 1, 2 or 3, and l+m≥1;

n denotes a number of from 1 to 6.

Suitable examples of urea derivatives include compounds according to Formulas II and III, below.

Formula II is below, in which Ph is a phenyl group, n is 1, 2, 3 or 4, the substituents —SO₃H are in ortho position, and the substituents —CH₃ is in ortho position:

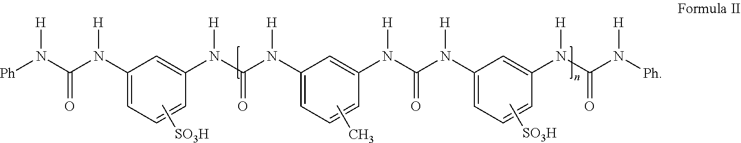

Formula III is below, in which Ph is a phenyl group, n is 1, 2, 3, or 4, the substituents —SO₃H are in ortho positions, and the substituent —CH₃ is in ortho position:

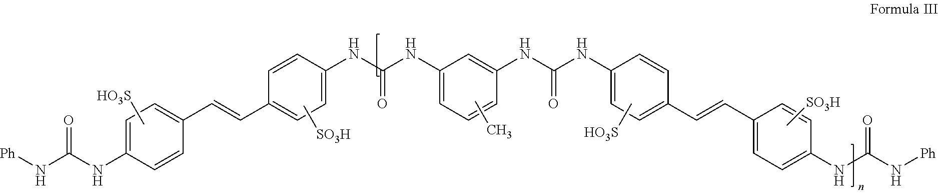

(iii) Polymers of Ethylenically Unsaturated Monomers, where the Polymers are Molecularly Imprinted with Dye

The dye control agent may comprise polymers of ethylenically unsaturated monomers, where the polymers are molecularly imprinted with dye. Methods of producing the molecular imprinted dyes are given in G. Z. Kyzas et al, Chemical Engineering Journal, Volume 149, Issues 1-3, 1 Jul. 2009, Pages 263-272.

One illustrative polymer can be synthesized as follows: 4.05 g (20 mmol) of ethylene glycol monomethacrylate, 0.34 g (4 mmol) of methacrylic acid, and 2.18 g (3.2 mmol) of disodium-8-anilino-5-[[4-[(3-sulfonatophenyl)diazenyl]naphthalen-1-yl]diazenyl]naphthalene-1-sulfonate (Acid Blue 113) in 100 mL of dimethylformamide are charged under a nitrogen atmosphere and stirred for 2 hours at room temperature. Next, 22 mg of azoisobutyronitrile is added; the reaction mixture is degassed for 15 minutes in the ultrasonic bath and is stirred for 12 hours at 75° C. The residue is separated, is washed with acetone and hot water, and is extracted with 500 mL of methanol in a Soxhlet extractor for 8 hours. After drying, 3.5 g of a brittle, dark purple product is obtained.

(iv) Fibers Consisting of Water-Insoluble Polyamide

The dye control agent may comprise fibers consisting of water-insoluble polyamide. The average diameter of the fibers may be not more than 2 m. Exemplary water-insoluble polyamides fibers include those produced from polyamide-6 and/or polyamide 6,6. The average fiber diameter can be measured by Scanning Electron Microscopy in conjunction with suitable image analysis software, for example the FiberMetric® fiber measurement software supplied by Phenom-World B.V., Eindhoven, The Netherlands.

(v) Polymer Obtainable from Polymerizing Benzoxazine Monomer Compounds

The dye control agent may comprise a polymer obtainable from polymerizing benzoxazine monomer compounds. The polymer obtainable from polymerizing benzoxazine monomer compounds may be selected from Formula IV, Formula V, or mixtures thereof:

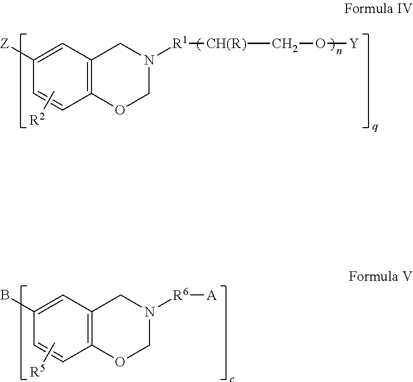

wherein for Formula IV and Formula V:

q is a whole number from 1 to 4,

n is a number from 2 to 20 000,

R in each repeat unit is selected independently of each other from hydrogen or linear or branched, optionally substituted alkyl groups that comprise 1 to 8 carbon atoms,

Z is selected from hydrogen (for q=1), alkyl (for q=1), alkylene (for q=2 to 4), carbonyl (for q=2), oxygen (for q=2), sulfur (for q=2), sulfoxide (for q=2), sulfone (for q=2) and a direct, covalent bond (for q=2),

R¹ stands for a covalent bond or a divalent linking group that contains 1 to 100 carbon atoms,

R² is selected from hydrogen, halogen, alkyl, alkenyl, and/or a divalent group that makes a corresponding naphthoxazine structure from the benzoxazine structure,

Y is selected from linear or branched, optionally substituted, alkyl groups that contain 1 to 15 carbon atoms, cycloaliphatic groups that optionally comprise one or more heteroatoms, aryl groups that optionally comprise one or more heteroatoms, and —(C═O)R₃, wherein R₃ is selected from linear or branched, optionally substituted, alkyl groups containing 1 to 15 carbon atoms and X—R₄, wherein X is selected from S, O, and NH and R₄ is selected from linear or branched, optionally substituted, alkyl groups containing 1 to 15 carbon atoms,

c is a whole number from 1 to 4,

B is selected from hydrogen (for c=1), alkyl (for c=1), alkylene (for c=2 to 4), carbonyl (for c=2), oxygen (for c=2), sulfur (for c=2), sulfoxide (for c=2), sulfone (for c=2) and a direct, covalent bond (for c=2), A is a hydroxyl group or a nitrogen-containing heterocycle,

R⁵ is selected from hydrogen, halogen, alkyl and alkenyl, or R⁵ is a divalent group that makes a corresponding naphthoxazine structure from the benzoxazine structure, and

R⁶ stands for a covalent bond or is a divalent linking group that contains 1 to 100 carbon atoms.

The polymer obtainable from polymerizing benzoxazine monomer compounds may be a compound according to Formula VI:

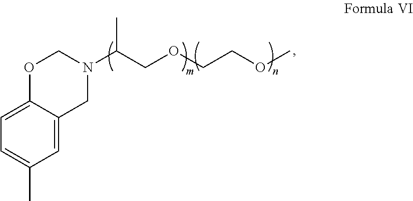

wherein typically, m=35, and wherein n=6.

The compound according to Formula VI may be produced by adding a solution of 16.22 p-cresol in 50 ml ethyl acetate dropwise over a period of 10 minutes to a solution of 9.38 g paraformaldehyde (96% conc.) in 50 ml ethyl acetate. 309.9 g Jeffamin M2070 (Huntsman, EO/PO ratio 10:31) in 200 ml ethyl acetate was then added over a period of 30 minutes, the temperature being maintained below 10° C. After stirring for 10 minutes, the reaction mixture was heated under reflux for 6 h. After cooling, the reaction mixture was filtered and the solvent together with any formed water were removed under vacuum. 318.90 g of the corresponding polymerisable benzoxazine compound was obtained.

### Amines

The cleaning compositions described herein may contain an amine. The cleaning compositions may include from about 0.1% to about 10%, or from about 0.2% to about 5%, or from about 0.5% to about 4%, or from about 0.1% to about 4%, or from about 0.1% to about 2%, by weight of the composition, of an amine. The amine can be subjected to protonation depending on the pH of the cleaning medium in which it is used. Non-limiting examples of amines include, but are not limited to, etheramines, cyclic amines, polyamines, oligoamines (e.g., triamines, diamines, pentamines, tetraamines), or combinations thereof. The compositions described herein may comprise an amine selected from the group consisting of oligoamines, etheramines, cyclic amines, and combinations thereof. In some aspects, the amine is not an alkanolamine. In some aspects, the amine is not a polyalkyleneimine. Examples of suitable oligoamines include tetraethylenepentamine, triethylenetetraamine, diethylenetriamine, and mixtures thereof. Etheramines and cyclic amines may be particularly preferred.

Bleach:

Suitable bleach includes sources of hydrogen peroxide, bleach activators, bleach catalysts, pre-formed peracids and any combination thereof. A particularly suitable bleach includes a combination of a source of hydrogen peroxide with a bleach activator and/or a bleach catalyst.

Source of Hydrogen Peroxide:

Suitable sources of hydrogen peroxide include sodium perborate and/or sodium percarbonate.

Bleach Activator:

Suitable bleach activators include tetra acetyl ethylene diamine and/or alkyl oxybenzene sulphonate.

Bleach Catalyst:

The composition may comprise a bleach catalyst. Suitable bleach catalysts include oxaziridinium bleach catalysts, transistion metal bleach catalysts, especially manganese and iron bleach catalysts. A suitable bleach catalyst has a structure corresponding to general formula below:

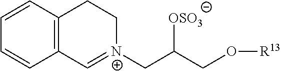

wherein R¹³ is selected from the group consisting of 2-ethylhexyl, 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl.

Pre-Formed Peracid:

Suitable pre-form peracids include phthalimido-peroxycaproic acid. However, it is preferred that the composition is substantially free of pre-formed peracid. By: “substantially free” it is meant: “no deliberately added”.

Other Enzymes:

Other suitable enzymes are bleaching enzymes, such as peroxidases/oxidases, which include those of plant, bacterial or fungal origin and variants thereof. Commercially available peroxidases include Guardzyme® (Novozymes A/S). Other suitable enzymes include choline oxidases and perhydrolases such as those used in Gentle Power Bleach™.

Brightener:

Suitable fluorescent brighteners include: di-styryl biphenyl compounds, e.g.

Tinopal® CBS-X, di-amino stilbene di-sulfonic acid compounds, e.g. Tinopal® DMS pure Xtra and Blankophor® HRH, and Pyrazoline compounds, e.g. Blankophor® SN, and coumarin compounds, e.g. Tinopal® SWN.

Preferred brighteners are: sodium 2 (4-styryl-3-sulfophenyl)-2H-napthol[1,2-d]triazole, disodium 4,4′-bis {[(4-anilino-6-(N methyl-N-2 hydroxyethyl)amino 1,3,5-triazin-2-yl)]amino} stilbene-2-2′ disulfonate, disodium 4,4′-bis {[(4-anilino-6-morpholino-1,3,5-triazin-2-yl)]amino} stilbene-2-2′ disulfonate, and disodium 4,4′-bis(2-sulfostyryl)biphenyl. A suitable fluorescent brightener is C.I. Fluorescent Brightener 260, which may be used in its beta or alpha crystalline forms, or a mixture of these forms.
pH
Preferably the pH of the compositions of the invention in a 1 wt % solution of deionised water is from above 6.5 to 11, more preferably from 7 to below 9. Should the compositions be used for antibacterial purposes, an acidic pH, typically from 1 to 6.5, preferably from 1 to 3 may be useful. Preferred cleaning compositions according to the invention, especially laundry cleaning compositions provide a pH less than 9, preferably from 7 to 8.9 for a 1 wt % solution in deionised water.

### Encapsulated Benefit Agent

The composition may further comprise an encapsulated benefit agent. The encapsulated benefit may comprise a shell surrounding a core. The core may comprise a benefit agent. The benefit agent may comprise perfume raw materials.

The shell may comprise a material selected from the group consisting of aminoplast copolymer, an acrylic, an acrylate, and mixtures thereof. The aminoplast copolymer may be melamine-formaldehyde, urea-formaldehyde, cross-linked melamine formaldehyde, or mixtures thereof.

The shell may be coated with one or more materials, such as a polymer, that aids in the deposition and/or retention of the perfume microcapsule on the site that is treated with the composition disclosed herein. The polymer may be a cationic polymer selected from the group consisting of polysaccharides, cationically modified starch, cationically modified guar, polysiloxanes, poly diallyl dimethyl ammonium halides, copolymers of poly diallyl dimethyl ammonium chloride and vinyl pyrrolidone, acrylamides, imidazoles, imidazolinium halides, imidazolium halides, poly vinyl amine, copolymers of poly vinyl amine and N-vinyl formamide, and mixtures thereof.

The core may comprise a benefit agent. Suitable benefit agents include a material selected from the group consisting of perfume raw materials, silicone oils, waxes, hydrocarbons, higher fatty acids, essential oils, lipids, skin coolants, vitamins, sunscreens, antioxidants, glycerine, catalysts, bleach particles, silicon dioxide particles, malodor reducing agents, odor-controlling materials, chelating agents, antistatic agents, softening agents, insect and moth repelling agents, colorants, antioxidants, chelants, bodying agents, drape and form control agents, smoothness agents, wrinkle control agents, sanitization agents, disinfecting agents, germ control agents, mold control agents, mildew control agents, antiviral agents, drying agents, stain resistance agents, soil release agents, fabric refreshing agents and freshness extending agents, chlorine bleach odor control agents, dye fixatives, dye transfer inhibitors, color maintenance agents, optical brighteners, color restoration/rejuvenation agents, anti-fading agents, whiteness enhancers, anti-abrasion agents, wear resistance agents, fabric integrity agents, anti-wear agents, anti-pilling agents, defoamers, anti-foaming agents, UV protection agents, sun fade inhibitors, anti-allergenic agents, enzymes, water proofing agents, fabric comfort agents, shrinkage resistance agents, stretch resistance agents, stretch recovery agents, skin care agents, glycerin, and natural actives, antibacterial actives, antiperspirant actives, cationic polymers, dyes and mixtures thereof. The benefit agent may comprise perfume raw materials.

The composition may comprise, based on total composition weight, from about 0.01% to about 10%, or from about 0.1% to about 5%, or from about 0.2% to about 1%, of encapsulated benefit agent. The encapsulated benefit agent may be friable and/or have a mean particle size of from about 10 microns to about 500 microns or from about 20 microns to about 200 microns.

Suitable encapsulated benefit agents may be obtained from Encapsys, LLC, of Appleton, Wis. USA.

Formaldehyde scavengers may also be used in or with such encapsulated benefit agents.

### Methods of Making the Composition

The present disclosure relates to methods of making the compositions described herein. The compositions of the invention may be solid (for example granules or tablets) or liquid form. Preferably the compositions are in liquid form. They may be made by any process chosen by the formulator, including by a batch process, a continuous loop process, or combinations thereof.

When in the form of a liquid, the compositions of the invention may be aqueous (typically above 2 wt % or even above 5 or 10 wt % total water, up to 90 or up to 80 wt % or 70 wt % total water) or non-aqueous (typically below 2 wt % total water content). Typically the compositions of the invention will be in the form of an aqueous solution or uniform dispersion or suspension of optical brightener, DTI and optional additional adjunct materials, some of which may normally be in solid form, that have been combined with the normally liquid components of the composition, such as the liquid alcohol ethoxylate nonionic, the aqueous liquid carrier, and any other normally liquid optional ingredients. Such a solution, dispersion or suspension will be acceptably phase stable. When in the form of a liquid, the detergents of the invention preferably have viscosity from 1 to 1500 centipoises (1-1500 mPa*s), more preferably from 100 to 1000 centipoises (100-1000 mPa*s), and most preferably from 200 to 500 centipoises (200-500 mPa*s) at 20s-1 and 21° C. Viscosity can be determined by conventional methods. Viscosity may be measured using an AR 550 rheometer from TA instruments using a plate steel spindle at 40 mm diameter and a gap size of 500 μm. The high shear viscosity at 20s-1 and low shear viscosity at 0.05-1 can be obtained from a logarithmic shear rate sweep from 0.1-1 to 25-1 in 3 minutes time at 21 C. The preferred rheology described therein may be achieved using internal existing structuring with detergent ingredients or by employing an external rheology modifier. More preferably the detergents, such as detergent liquid compositions have a high shear rate viscosity of from about 100 centipoise to 1500 centipoise, more preferably from 100 to 1000 cps. Unit Dose detergents, such as detergent liquid compositions have high shear rate viscosity of from 400 to 1000 cps. Detergents such as laundry softening compositions typically have high shear rate viscosity of from 10 to 1000, more preferably from 10 to 800 cps, most preferably from 10 to 500 cps. Hand dishwashing compositions have high shear rate viscosity of from 300 to 4000 cps, more preferably 300 to 1000 cps.

The cleaning and/or treatment compositions in the form of a liquid herein can be prepared by combining the components thereof in any convenient order and by mixing, e.g., agitating, the resulting component combination to form a phase stable liquid detergent composition. In a process for preparing such compositions, a liquid matrix is formed containing at least a major proportion, or even substantially all, of the liquid components, e.g., nonionic surfactant, the non-surface active liquid carriers and other optional liquid components, with the liquid components being thoroughly admixed by imparting shear agitation to this liquid combination. For example, rapid stirring with a mechanical stirrer may usefully be employed. While shear agitation is maintained, substantially all of any anionic surfactants and the solid form ingredients can be added. Agitation of the mixture is continued, and if necessary, can be increased at this point to form a solution or a uniform dispersion of insoluble solid phase particulates within the liquid phase. After some or all of the solid-form materials have been added to this agitated mixture, particles of any enzyme material to be included, e.g., enzyme granulates, are incorporated. As a variation of the composition preparation procedure hereinbefore described, one or more of the solid components may be added to the agitated mixture as a solution or slurry of particles premixed with a minor portion of one or more of the liquid components. After addition of all of the composition components, agitation of the mixture is continued for a period of time sufficient to form compositions having the requisite viscosity and phase stability characteristics. Frequently this will involve agitation for a period of from about 30 to 60 minutes.

The adjunct ingredients in the compositions of this invention may be incorporated into the composition as the product of the synthesis generating such components, either with or without an intermediate purification step. Where there is no purification step, commonly the mixture used will comprise the desired component or mixtures thereof (and percentages given herein relate to the weight percent of the component itself unless otherwise specified) and in addition unreacted starting materials and impurities formed from side reactions and/or incomplete reaction. For example, for an ethoxylated or substituted component, the mixture will likely comprise different degrees of ethoxylation/substitution.

### Method of Use

The present disclosure relates to methods of using the cleaning compositions of the present disclosure to clean a surface, such as a hard surface or textile. In general, the method includes mixing the cleaning composition as described herein with water to form an aqueous aqueous wash liquor and contacting a surface, preferably a textile, with the aqueous wash liquor in a washing step. Thus, the glycogen-debranching enzyme, second amylase, nonionic surfactant and optional adjunct may be added to the water separately to form the aqueous wash liquor, or they may be premixed with optional other cleaning adjuncts to form a cleaning composition which is then mixed with water to form the aqueous wash liquor. The target surface may include a greasy soil.

The compositions of this invention, typically prepared as hereinbefore described, can be used to form aqueous washing/treatment solutions for use in the laundering/treatment of fabrics and/or hard surfaces. Generally, an effective amount of such a composition is added to water, for example in a conventional automatic washing machine, to form such aqueous cleaning/washing solutions. The aqueous washing solution so formed is then contacted, typically under agitation, with the hard surfaces or fabrics to be laundered/treated therewith. An effective amount of the detergent composition herein added to water to form aqueous cleaning solutions can comprise amounts sufficient to form from about 500 to 25,000 ppm, or from 500 to 15,000 ppm of composition in aqueous washing solution, or from about 1,000 to 3,000 ppm of the detergent compositions herein will be provided in aqueous washing solution.

Typically, the aqueous wash liquor is formed by contacting the cleaning composition with wash water in such an amount so that the concentration of the detergent in the aqueous wash liquor is from above 0 g/l to 5 g/l, or from 1 g/l, and to 4.5 g/l, or to 4.0 g/l, or to 3.5 g/l, or to 3.0 g/l, or to 2.5 g/l, or even to 2.0 g/l, or even to 1.5 g/l. The method of cleaning fabric or textile may be carried out in a top-loading or front-loading automatic washing machine, or can be used in a hand-wash application. In these applications, the aqueous wash liquor formed and concentration of cleaning composition in the aqueous wash liquor is that of the main wash cycle. Any input of water during any optional rinsing step(s) is not included when determining the volume of the aqueous wash liquor.

The aqueous wash liquor may comprise 40 litres or less of water, or 30 litres or less, or 20 litres or less, or 10 litres or less, or 8 litres or less, or even 6 litres or less of water. The aqueous wash liquor may comprise from above 0 to 15 litres, or from 2 litres, and to 12 litres, or even to 8 litres of water. Typically from 0.01 kg to 2 kg of fabric per litre of aqueous wash liquor is dosed into said aqueous wash liquor. Typically from 0.01 kg, or from 0.05 kg, or from 0.07 kg, or from 0.10 kg, or from 0.15 kg, or from 0.20 kg, or from 0.25 kg fabric per litre of aqueous wash liquor is dosed into said aqueous wash liquor. Optionally, 50 g or less, or 45 g or less, or 40 g or less, or 35 g or less, or 30 g or less, or 25 g or less, or 20 g or less, or even 15 g or less, or even 10 g or less of the composition is contacted to water to form the aqueous wash liquor. Such compositions are typically employed at concentrations of from about 500 ppm to about 15,000 ppm in solution. When the wash solvent is water, the water temperature typically ranges from about 5° C. to about 90° C. and, when the situs comprises a fabric, the water to fabric ratio is typically from about 1:1 to about 30:1. Typically the aqueous wash liquor comprising the detergent of the invention has a pH of from 3 to 11.5.

In one aspect, such method comprises the steps of optionally washing and/or rinsing said surface or fabric, contacting said surface or fabric with any composition disclosed in this specification then optionally washing and/or rinsing said surface or fabric is disclosed, with an optional drying step.

Drying of such surfaces or fabrics may be accomplished by any one of the common means employed either in domestic or industrial settings: machine drying or open-air drying. The fabric may comprise any fabric capable of being laundered in normal consumer or institutional use conditions, and the invention is particularly suitable for synthetic textiles such as polyester and nylon and especially for treatment of mixed fabrics and/or fibres comprising synthetic and cellulosic fabrics and/or fibres. As examples of synthetic fabrics are polyester, nylon, these may be present in mixtures with cellulosic fibres, for example, polycotton fabrics. The solution typically has a pH of from 7 to 11, more usually 8 to 10.5. The compositions are typically employed at concentrations from 500 ppm to 5,000 ppm in solution. The water temperatures typically range from about 5° C. to about 90° C. The water to fabric ratio is typically from about 1:1 to about 30:1.

### EXAMPLES

### Example

The wash performance was determined using a 6 well plate (Costar 3516). Wash solutions were prepared by adding 1.87 g/L dosage of detergent composition comprising 3.7 wt % C12-15 alkyl ethoxylate nonionic surfactant having an average ethoxylation degree of 7; 22 wt % LAS and 15 wt % C12-15 alkyl ethoxylated sulfate surfactant having an average ethoxylation degree of 3. The addition of isoamylase (SEQ ID NO: 1) and amylase (Stainzyme™) enzymes were then as set out in the table below. Starch stained fabric swatches (stained with Tapioca or Salad dressing stains) were washed in detergent solution prepared by dissolution of the detergent with magnetic stirring for 2 min. The wash temperature was 20° C. and during the wash, the stained fabric swatches were agitated for 30 min, followed by a 2 minute rinse step. The process was repeated 4 times for each test.

The stains were analyzed using image analysis and results are presented as stain removal index (SRI) values, where 0 represents no removal and 100 complete removal.

| | SRI/30 min |
|---|---|
| Tapioca starch | wash/20° C. |
| Nil enzyme | 19.0 |
| Isoamylase 0.65 ppm | 14.8 |
| Amylase 0.65 ppm | 44.1 |
| Amylase 1.3 ppm | 51.4 |
| Amylase 0.65 ppm + Isoamylase 0.65 ppm | 54.9 |

| | SRI/30 min |
|---|---|
| Salad dressing | wash/20° C. |
| Nil enzyme | 5.2 |
| Isoamylase 0.65 ppm | 7.4 |
| Amylase 0.65 ppm | 6.1 |
| Amylase 1.3 ppm | 6.0 |
| Amylase 0.65 ppm + Isoamylase 0.65 ppm | 8.8 |

### Formulation Examples

The following are illustrative examples of cleaning compositions according to the present disclosure and are not intended to be limiting.

### Examples 1-7: Heavy Duty Liquid Laundry Detergent Compositions

| | 1 | 2 | 3 | 4 | 5 | 6 | 7 |
|---|---|---|---|---|---|---|---|
| Ingredients | % weight | | | | | | |
| AE_{1.8}S | 6.77 | 5.16 | 1.36 | 1.30 | — | — | — |
| AE₃S | — | — | — | — | 0.45 | — | |
| LAS | 0.86 | 2.06 | 2.72 | 0.68 | 0.95 | 1.56 | 3.55 |
| HSAS | 1.85 | 2.63 | 1.02 | — | — | — | — |
| AE9 | 6.32 | 9.85 | 10.20 | 7.92 | | | |
| AE8 | | | | | | | 35.45 |
| AE7 | | | | | 8.40 | 12.44 | |
| C₁₂₋₁₄ dimethyl Amine Oxide | 0.30 | 0.73 | 0.23 | 0.37 | — | — | — |
| C₁₂₋₁₈ Fatty Acid | 0.80 | 1.90 | 0.60 | 0.99 | 1.20 | — | 15.00 |
| Citric Acid | 2.50 | 3.96 | 1.88 | 1.98 | 0.90 | 2.50 | 0.60 |
| Optical Brightener 1 | 1.00 | 0.80 | 0.10 | 0.30 | 0.05 | 0.50 | 0.001 |
| Optical Brightener 3 | 0.001 | 0.05 | 0.01 | 0.20 | 0.50 | — | 1.00 |
| Sodium formate | 1.60 | 0.09 | 1.20 | 0.04 | 1.60 | 1.20 | 0.20 |
| DTI 1 | 0.32 | 0.05 | — | 0.60 | 0.10 | 0.60 | 0.01 |
| DTI 2 | 0.32 | 0.10 | 0.60 | 0.60 | 0.05 | 0.40 | 0.20 |
| Sodium hydroxide | 2.30 | 3.80 | 1.70 | 1.90 | 1.70 | 2.50 | 2.30 |
| Monoethanolamine | 1.40 | 1.49 | 1.00 | 0.70 | — | — | — |
| Diethylene glycol | 5.50 | — | 4.10 | — | — | — | — |
| Chelant 1 | 0.15 | 0.15 | 0.11 | 0.07 | 0.50 | 0.11 | 0.80 |
| 4-formyl-phenylboronic acid | — | — | — | — | 0.05 | 0.02 | 0.01 |
| Sodium tetraborate | 1.43 | 1.50 | 1.10 | 0.75 | — | 1.07 | — |
| Ethanol | 1.54 | 1.77 | 1.15 | 0.89 | — | 3.00 | 7.00 |
| Polymer 1 | 0.10 | — | — | — | — | — | 2.00 |
| Polymer 2 | 0.30 | 0.33 | 0.23 | 0.17 | — | — | — |
| Polymer 3 | — | — | — | — | — | — | 0.80 |
| Polymer 4 | 0.80 | 0.81 | 0.60 | 0.40 | 1.00 | 1.00 | — |
| 1,2-Propanediol | — | 6.60 | — | 3.30 | 0.50 | 2.00 | 8.00 |
| Structurant | 0.10 | — | — | — | — | — | 0.10 |
| Perfume | 1.60 | 1.10 | 1.00 | 0.80 | 0.90 | 1.50 | 1.60 |
| Perfume encapsulate | 0.10 | 0.05 | 0.01 | 0.02 | 0.10 | 0.05 | 0.10 |
| Protease | 0.80 | 0.60 | 0.70 | 0.90 | 0.70 | 0.60 | 1.50 |
| Mannanase | 0.07 | 0.05 | 0.045 | 0.06 | 0.04 | 0.045 | 0.10 |
| Amylase 1 | 0.30 | — | 0.30 | 0.10 | — | 0.40 | 0.10 |
| Amylase 2 | — | 0.20 | 0.10 | 0.15 | 0.07 | — | 0.10 |
| Amylase 4, preferably from h) | 0.30 | 0.1 | — | 0.15 | 0.03 | 0.40 | 0.10 |
| Isoamylase | 0.30 | 0.20 | 0.10 | 0.07 | 0.2 | 0.02 | 0.30 |
| Xyloglucanase | 0.20 | 0.10 | — | — | 0.05 | 0.05 | 0.20 |
| Lipase | 0.40 | 0.20 | 0.30 | 0.10 | 0.20 | — | — |
| Polishing enzyme | — | 0.04 | — | — | — | 0.004 | — |
| Extracellular-polymer- | 0.05 | 0.03 | 0.01 | 0.03 | 0.03 | 0.003 | 0.003 |
| degrading enzyme | | | | | | | |
| Dispersin B | — | — | — | 0.05 | 0.03 | 0.001 | 0.001 |
| Acid Violet 50 | 0.05 | — | — | — | — | — | 0.005 |
| Direct Violet 9 | — | — | — | — | — | 0.05 | — |
| Violet DD | — | 0.035 | 0.02 | 0.037 | 0.04 | — | — |
| Water insoluble plant fiber | 0.2 | — | — | — | 1.2 | — | — |
| Dye control agent | — | 0.3 | — | 0.5 | — | 0.3 | — |
| Alkoxylated polyaryl/ | — | — | 1.2 | — | — | — | 3.1 |
| polyalkyl phenol | | | | | | | |

| | |
|---|---|
| Water, dyes & minors | Balance |
| pH | 8.2 |

Based on total cleaning and/or treatment composition weight. Enzyme levels are reported as raw material.

### Examples 8 to 18: Unit Dose Compositions

These examples provide various formulations for unit dose laundry detergents. Compositions 8 to 12 comprise a single unit dose compartment. The film used to encapsulate the compositions is polyvinyl alcohol-based film.

| | 8 | 9 | 10 | 11 | 12 |
|---|---|---|---|---|---|
| Ingredients | % weight | | | | |
| LAS | 19.09 | 16.76 | 8.59 | 6.56 | 3.44 |
| AE3S | 1.91 | 0.74 | 0.18 | 0.46 | 0.07 |
| AE7 | 14.00 | 17.50 | 26.33 | 28.08 | 31.59 |
| Citric Acid | 0.6 | 0.6 | 0.6 | 0.6 | 0.6 |
| C12-15 Fatty Acid | 14.8 | 14.8 | 14.8 | 14.8 | 14.8 |
| Polymer 3 | 4.0 | 4.0 | 4.0 | 4.0 | 4.0 |
| Chelant 2 | 1.2 | 1.2 | 1.2 | 1.2 | 1.2 |
| Optical Brightener 1 | 0.20 | 0.25 | 0.01 | 0.01 | 0.50 |
| Optical Brightener 2 | 0.20 | — | 0.25 | 0.03 | 0.01 |
| Optical Brightener 3 | 0.18 | 0.09 | 0.30 | 0.01 | — |
| DTI 1 | 0.10 | — | 0.20 | 0.01 | 0.05 |
| DTI 2 | — | 0.10 | 0.20 | 0.25 | 0.05 |
| Glycerol | 6.1 | 6.1 | 6.1 | 6.1 | 6.1 |
| Monoethanol amine | 8.0 | 8.0 | 8.0 | 8.0 | 8.0 |
| Tri-isopropanol amine | — | — | 2.0 | — | — |
| Tri-ethanol amine | — | 2.0 | — | — | — |
| Cumene sulfonate | — | — | — | — | 2.0 |
| Protease | 0.80 | 0.60 | 0.07 | 1.00 | 1.50 |
| Mannanase | 0.07 | 0.05 | 0.05 | 0.10 | 0.01 |
| Amylase 1 | 0.20 | 0.20 | 0.30 | 0.50 | 0.05 |
| Amylase 4 | 0.11 | — | 0.10 | — | 0.50 |
| Isoamylase | 0.10 | 0.10 | 0.20 | 0.20 | 0.10 |
| Polishing enzyme | 0.005 | 0.05 | — | — | — |
| Extracellular-polymer- | 0.005 | 0.05 | 0.005 | 0.010 | 0.005 |
| degrading enzyme | | | | | |
| Dispersin B | 0.010 | 0.05 | 0.005 | 0.005 | — |
| Cyclohexyl dimethanol | — | — | — | 2.0 | — |
| Acid violet 50 | 0.03 | 0.02 | | | |
| Violet DD | | | 0.01 | 0.05 | 0.02 |
| Structurant | 0.14 | 0.14 | 0.14 | 0.14 | 0.14 |
| Perfume | 1.9 | 1.9 | 1.9 | 1.9 | 1.9 |
| Water insoluble plant fiber | — | 0.3 | | — | 0.1 |
| Dye control agent | — | — | 0.2 | — | — |
| Alkoxylated polyaryl/ | 0.3 | — | — | 0.9 | — |
| polyalkyl phenol | | | | | |

| | |
|---|---|
| Water and miscellaneous | To 100% |
| pH | 7.5-8.2 |

Based on total cleaning and/or treatment composition weight. Enzyme levels are reported as raw material.

In the following examples the unit dose has three compartments, but similar compositions can be made with two, four or five compartments. The film used to encapsulate the compartments is polyvinyl alcohol.

| Base compositions | 13 | 14 | 15 | 16 |
|---|---|---|---|---|
| Ingredients | % weight | | | |
| HLAS | 26.82 | 16.35 | 7.50 | 3.34 |
| AE7 | 17.88 | 16.35 | 22.50 | 30.06 |
| Citric Acid | 0.5 | 0.7 | 0.6 | 0.5 |
| C12-15 Fatty acid | 16.4 | 6.0 | 11.0 | 13.0 |
| Polymer 1 | 2.9 | 0.1 | — | — |
| Polymer 3 | 1.1 | 5.1 | 2.5 | 4.2 |
| Cationic cellulose polymer | — | — | 0.3 | 0.5 |
| Polymer 6 | — | 1.5 | 0.3 | 0.2 |
| Chelant 2 | 1.1 | 2.0 | 0.6 | 1.5 |
| Optical Brightener 1 | 0.20 | 0.25 | 0.01 | 0.005 |
| Optical Brightener 3 | 0.18 | 0.09 | 0.30 | 0.005 |
| DTI 1 | 0.1 | — | 0.2 | — |
| DTI 2 | — | 0.1 | 0.2 | — |
| Glycerol | 5.3 | 5.0 | 5.0 | 4.2 |
| Monoethanolamine | 10.0 | 8.1 | 8.4 | 7.6 |
| Polyethylene glycol | — | — | 2.5 | 3.0 |
| Potassium sulfite | 0.2 | 0.3 | 0.5 | 0.7 |
| Protease | 0.80 | 0.60 | 0.40 | 0.80 |
| Amylase 4 | 0.20 | 0.20 | 0.20 | 0.30 |
| Isoamylase | 0.20 | 0.05 | 0.05 | 0.20 |
| Polishing enzyme | — | — | 0.005 | 0.005 |
| Extracellular-polymer- | 0.05 | 0.010 | 0.005 | 0.005 |
| degrading enzyme | | | | |
| Dispersin B | — | 0.010 | 0.010 | 0.010 |
| MgCl₂ | 0.2 | 0.2 | 0.1 | 0.3 |
| Structurant | 0.2 | 0.1 | 0.2 | 0.2 |
| Acid Violet 50 | 0.04 | 0.03 | 0.05 | 0.03 |
| Perfume/encapsulates | 0.10 | 0.30 | 0.01 | 0.05 |
| Water-insoluble plant fiber | — | — | 0.4 | — |
| Dye control agent | — | 0.6 | — | 1.2 |
| Alkoxylated polyaryl/ | 1.1 | — | — | — |
| polyalkyl phenol | | | | |

| | |
|---|---|
| Solvents and misc. | To 100% |
| pH | 7.0-8.2 |

| Finishing compositions | 17 | | | 18 | | |
|---|---|---|---|---|---|---|
| Compartment | A | B | C | A | B | C |
| Volume of each compartment | 40 ml | 5 ml | 5 ml | 40 ml | 5 ml | 5 ml |
| Ingredients | Active material in Wt. % | | | | | |
| Perfume | 1.6 | 1.6 | 1.6 | 1.6 | 1.6 | 1.6 |
| Violet DD | 0 | 0.006 | 0 | 0 | 0.004 | — |
| TiO2 | — | — | 0.1 | — | | 0.1 |
| Sodium Sulfite | 0.4 | 0.4 | 0.4 | 0.3 | 0.3 | 0.3 |
| Polymer 5 | — | | | 2 | — | — |
| Hydrogenated castor oil | 0.14 | 0.14 | 0.14 | 0.14 | 0.14 | 0.14 |
| Base Composition 13, 14, 15 or | Add to 100% | | | | | |
| 16 | | | | | | |

Based on total cleaning and/or treatment composition weight, enzyme levels are reported as raw material.

### Examples 19 to 24: Granular Laundry Detergent Compositions for Hand Washing or Washing Machines, Typically Top-Loading Washing Machines

| | 19 | 20 | 21 | 22 | 23 | 24 |
|---|---|---|---|---|---|---|
| Ingredient | % weight | | | | | |
| LAS | 11.33 | 10.81 | 7.04 | 4.20 | 3.92 | 2.29 |
| Quaternary ammonium | 0.70 | 0.20 | 1.00 | 0.60 | — | — |
| AE3S | 0.51 | 0.49 | 0.32 | — | 0.08 | 0.10 |
| AE7 | 8.36 | 11.50 | 12.54 | 11.20 | 16.00 | 21.51 |
| Sodium Tripolyphosphate | 5.0 | — | 4.0 | 9.0 | 2.0 | — |
| Zeolite A | — | 1.0 | — | 1.0 | 4.0 | 1.0 |
| Sodium silicate 1.6R | 7.0 | 5.0 | 2.0 | 3.0 | 3.0 | 5.0 |
| Sodium carbonate | 20.0 | 17.0 | 23.0 | 14.0 | 14.0 | 16.0 |
| Polyacrylate MW 4500 | 1.0 | 0.6 | 1.0 | 1.0 | 1.5 | 1.0 |
| Polymer 6 | 0.1 | 0.2 | — | — | 0.1 | — |
| Carboxymethyl cellulose | 1.0 | 0.3 | 1.0 | 1.0 | 1.0 | 1.0 |
| Acid Violet 50 | 0.05 | — | 0.02 | — | 0.04 | — |
| Violet DD | — | 0.03 | — | 0.03 | — | 0.03 |
| Protease 2 | 0.10 | 0.10 | 0.10 | 0.10 | — | 0.10 |
| Amylase 1, 2 or 3 | 0.03 | 0.04 | 0.03 | 0.03 | 0.03 | 0.30 |
| Isoamylase | 0.03 | 0.06 | 0.10 | 0.03 | 0.10 | 0.03 |
| Lipase | 0.03 | 0.07 | 0.30 | 0.10 | 0.07 | 0.40 |
| Polishing enzyme | 0.002 | — | 0.05 | — | 0.02 | — |
| Extracellular-polymer-degrading | 0.001 | 0.001 | 0.01 | 0.05 | 0.002 | 0.02 |
| enzyme | | | | | | |
| Dispersin B | 0.001 | 0.001 | 0.05 | — | 0.001 | — |
| Optical Brightener 1 | 0.200 | 0.001 | 0.300 | 0.650 | 0.050 | 0.001 |
| Optical Brightener 2 | 0.060 | — | 0.650 | 0.180 | 0.200 | 0.060 |
| Optical Brightener 3 | 0.100 | 0.060 | 0.050 | — | 0.030 | 0.300 |
| Chelant 1 | 0.60 | 0.80 | 0.60 | 0.25 | 0.60 | 0.60 |
| DTI 1 | 0.32 | 0.15 | 0.15 | — | 0.10 | 0.10 |
| DTI 2 | 0.32 | 0.15 | 0.30 | 0.30 | 0.10 | 0.20 |
| Sodium Percarbonate | — | 5.2 | 0.1 | — | — | — |
| Sodium Perborate | 4.4 | — | 3.85 | 2.09 | 0.78 | 3.63 |
| Nonanoyloxybenzensulfonate | 1.9 | 0.0 | 1.66 | 0.0 | 0.33 | 0.75 |
| Tetraacetylehtylenediamine | 0.58 | 1.2 | 0.51 | 0.0 | 0.015 | 0.28 |
| Photobleach | 0.0030 | 0.0 | 0.0012 | 0.0030 | 0.0021 | — |
| S-ACMC | 0.1 | 0.0 | 0.0 | 0.0 | 0.06 | 0.0 |
| Water-insoluble plant fiber | — | — | 2.4 | — | — | — |
| Dye control agent | — | — | — | 2.2 | — | — |
| Alkoxylated polyaryl/ | 1.9 | — | — | — | 2.2 | — |
| polyalkyl phenol | | | | | | |
| Acyl hydrazone | — | 0.7 | — | — | — | 0.6 |

| | |
|---|---|
| Sulfate/Moisture | Balance |

### Examples 25-30: Granular Laundry Detergent Compositions Typically for Front-Loading Automatic Washing Machines

| | 25 | 26 | 27 | 28 | 29 | 30 |
|---|---|---|---|---|---|---|
| Ingredient | % weight | | | | | |
| LAS | 6.08 | 5.05 | 4.27 | 3.24 | 2.30 | 1.09 |
| AE3S | — | 0.90 | 0.21 | 0.18 | — | 0.06 |
| AS | 0.34 | — | — | — | — | — |
| AE7 | 4.28 | 5.95 | 6.72 | 7.98 | 9.20 | 10.35 |
| Quaternary ammonium | 0.5 | — | — | 0.3 | — | — |
| Crystalline layered silicate | 4.1 | — | 4.8 | — | — | — |
| Zeolite A | 5.0 | — | 2.0 | — | 2.0 | 2.0 |
| Citric acid | 3.0 | 4.0 | 3.0 | 4.0 | 2.5 | 3.0 |
| Sodium carbonate | 11.0 | 17.0 | 12.0 | 15.0 | 18.0 | 18.0 |
| Sodium silicate 2R | 0.08 | — | 0.11 | — | — | — |
| Optical Brightener 1 | — | 0.25 | 0.05 | 0.01 | 0.10 | 0.02 |
| Optical Brightener 2 | — | — | 0.25 | 0.20 | 0.01 | 0.08 |
| Optical Brightener 3 | — | 0.06 | 0.04 | 0.15 | — | 0.05 |
| DTI 1 | 0.08 | — | 0.04 | — | 0.10 | 0.01 |
| DTI 2 | 0.08 | — | 0.04 | 0.10 | 0.10 | 0.02 |
| Soil release agent | 0.75 | 0.72 | 0.71 | 0.72 | — | — |
| Acrylic/maleic acid copolymer | 1.1 | 3.7 | 1.0 | 3.7 | 2.6 | 3.8 |
| Carboxymethyl cellulose | 0.2 | 1.4 | 0.2 | 1.4 | 1.0 | 0.5 |
| Protease 3 | 0.20 | 0.20 | 0.30 | 0.15 | 0.12 | 0.13 |
| Amylase 2 or 3 | 0.20 | 0.15 | 0.20 | 0.30 | 0.15 | 0.15 |
| Lipase | 0.05 | 0.15 | 0.10 | — | — | — |
| Amylase 4 | 0.03 | 0.07 | — | — | 0.05 | 0.05 |
| Cellulase 2 | — | — | — | — | 0.10 | 0.10 |
| Isoamylase | 0.20 | 0.07 | 0.10 | 0.20 | 0.07 | 0.20 |
| Polishing enzyme | 0.003 | 0.005 | 0.020 | — | — | — |
| Extracellular-polymer-degrading | 0.002 | 0.010 | 0.020 | 0.020 | 0.010 | 0.003 |
| enzyme | | | | | | |
| Dispersin B | 0.002 | 0.010 | 0.020 | 0.020 | 0.010 | 0.002 |
| Tetraacetylehtylenediamine | 3.6 | 4.0 | 3.6 | 4.0 | 2.2 | 1.4 |
| Sodium percabonate | 13.0 | 13.2 | 13.0 | 13.2 | 16.0 | 14.0 |
| Chelant 3 | — | 0.2 | — | 0.2 | — | 0.2 |
| Chelant 2 | 0.2 | — | 0.2 | — | 0.2 | 0.2 |
| MgSO₄ | — | 0.42 | — | 0.42 | — | 0.4 |
| Perfume | 0.5 | 0.6 | 0.5 | 0.6 | 0.6 | 0.6 |
| Suds suppressor agglomerate | 0.05 | 0.10 | 0.05 | 0.10 | 0.06 | 0.05 |
| Soap | 0.45 | 0.45 | 0.45 | 0.45 | — | — |
| Acid Violet 50 | 0.04 | — | 0.05 | — | 0.04 | — |
| Violet DD | — | 0.04 | — | 0.05 | — | 0.04 |
| S-ACMC | 0.01 | 0.01 | — | 0.01 | — | — |
| Direct Violet 9 (active) | — | — | 0.0001 | 0.0001 | — | — |
| Water-insoluble plant fiber | 1.23 | — | — | — | — | — |
| Dye control agent | — | 0.1 | — | — | — | — |
| Alkoxylated polyaryl/ | — | — | 0.81 | — | — | — |
| polyalkyl phenol | | | | | | |
| Acyl hydrazone | — | — | — | 0.3 | 0.06 | 0.3 |

| | |
|---|---|
| Sulfate/Water & Miscellaneous | Balance |

Acyl hydrazone Acyl hydrazone in accordance with the present disclosure, for example 4-(2-(2-((2-hydroxyphenylmethyl)methylene)-hydrazinyl)-2-oxoethyl)-4-methylchloride suppled as Tinocat® LT (BASF)
AE1.8S is C₁₂₋₁₅ alkyl ethoxy (1.8) sulfate
AE3S is C₁₂₋₁₅ alkyl ethoxy (3) sulfate
AE7 is C₁₂-1₃ alcohol ethoxylate, with an average degree of ethoxylation of 7
AE8 is C₁₂₋₁₃ alcohol ethoxylate, with an average degree of ethoxylation of 8
AE9 is C₁₂₋₁₃ alcohol ethoxylate, with an average degree of ethoxylation of 9
Alkoxylated polyaryl/is alkoxylated polyaryl/polyalkyl phenol in accordance with the polyalkyl phenol present disclosure, for example Emulsogen® TS160, Hostapal® BV conc., Sapogenat® T110 or Sapogenat® T139, all from Clariant
Amylase 1 is Stainzyme®, 15 mg active/g
Amylase 2 is Natalase®, 29 mg active/g
Amylase 3 is Stainzyme Plus®, 20 mg active/g,
Amylase 4 is Amylase as described in any of a) to j) herein, 20 mg active/g
Isoamylase is SEQ ID NO. 1 according to the invention or a variant thereof having glycogen-debranching activity and at least 60% or preferably at least 70% or preferably at least 80% or at least 90% identity with SEQ ID NO:1
AS is C₁₂₋₁₄ alkylsulfate
Cellulase 2 is Celluclean™, 15.6 mg active/g
Xyloglucanase is Whitezyme®, 20 mg active/g
Chelant 1 is diethylene triamine pentaacetic acid
Chelant 2 is 1-hydroxyethane 1,1-diphosphonic acid
Chelant 3 is sodium salt of ethylenediamine-N,N′-disuccinic acid, (S,S) isomer (EDDS)
Dispersin B is a glycoside hydrolase, reported as 1000 mg active/g
DTI 1 is poly(4-vinylpyridine-1-oxide) (such as Chromabond S-403E®),
DTI 2 is poly(1-vinylpyrrolidone-co-1-vinylimidazole) (such as Sokalan HP56®).
Dye control agent Dye control agent in accordance with the present disclosure, for example Suparex® O.IN (M1), Nylofixan® P (M2), Nylofixan® PM (M3), or Nylofixan® HF (M4)
HSAS is mid-branched alkyl sulfate as disclosed in U.S. Pat. Nos. 6,020,303 and 6,060,443
LAS is linear alkylbenzenesulfonate having an average aliphatic carbon chain length C₉-C₁₅ (HLAS is acid form).
Lipase is Lipex®, 18 mg active/g
Mannanase is Mannaway®, 25 mg active/g
Optical Brightener 1 is disodium 4,4′-bis {[4-anilino-6-morpholino-s-triazin-2-yl]-amino}-2,2′-stilbenedisulfonate
Optical Brightener 2 is disodium 4,4′-bis-(2-sulfostyryl)biphenyl (sodium salt)
Optical Brightener 3 is Optiblanc SPL10® from 3V Sigma
Perfume encapsulate is a core-shell melamine formaldehyde perfume microcapsules.
Photobleach is a sulfonated zinc phthalocyanine
Polishing enzyme is Para-nitrobenzyl esterase, reported as 1000 mg active/g
Polymer 1 is bis((C₂H₅O)(C₂H₄O)n)(CH₃)—N⁺—CₓH₂ₓ—N⁺—(CH₃)-bis((C₂H₅O)(C₂H₄O)n), wherein n=20-30, x=3 to 8 or sulphated or sulfonated variants thereof
Polymer 2 is ethoxylated (EO15) tetraethylene pentamine
Polymer 3 is ethoxylated polyethylenimine
Polymer 4 is ethoxylated hexamethylene diamine, Baxxodur® ECX 210 from BASF SE, Baxxodur® EC 301 from BASF SE, or a polyetheramine comprising 1 mol 2-butyl-2-ethyl-1,3-propanediol+5.0 mole propylene oxide, aminated.
Polymer 5 is Acusol 305, provided by Rohm&Haas
Polymer 6 is a polyethylene glycol polymer grafted with vinyl acetate side chains, provided by BASF.
Protease is Purafect Prime®, 40.6 mg active/g
Protease 2 is Savinase®, 32.89 mg active/g
Protease 3 is Purafect®, 84 mg active/g
Quaternary ammonium is C₁₂₋₁₄ Dimethylhydroxyethyl ammonium chloride
S-ACMC is Reactive Blue 19 Azo-CM-Cellulose provided by Megazyme
Soil release agent is Repel-o-Tex® SF2
Structurant is Hydrogenated Castor Oil
Violet DD is a thiophene azo dye provided by Milliken
Water insoluble plant fiber is water insoluble plant fiber in accordance with the present disclosure, for example Herbacel AQ+ Type N, supplied by Herbafood Ingredients GmbH, Werder, Germany.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning composition comprising a) a glycogen-debranching enzyme having activity to 1,6-glucosidic linkages; b) a second amylase having activity to alpha-1,4-glycosidic bonds and exhibiting at least 70% identity with SEQ ID NO:2, the wild-type enzyme from Bacillus SP722; and c) a cleaning adjunct.

2. A composition according to claim 1 wherein the glycogen-debranching enzyme has activity EC 3.2.1.68, EC 3.2.1.33, EC 3.2.1.196, EC 3.2.1.10, EC 3.2.1.41 or EC 3.2.1.142.

3. A composition according to claim 2 wherein the glycogen-debranching enzyme has activity EC 3.2.1.68.

4. A composition according to claim 1 wherein the glycogen-debranching enzyme has at least 80% identity with the amino acid sequence shown in SEQ ID NO: 1.

5. A composition according to claim 1 wherein the glycogen-debranching enzyme is selected from Glycoside Hydrolase Family 13.

6. A composition according to claim 1 wherein the glycogen-debranching enzyme is obtainable from Pseudomonas, Corynebacterium glutamicum or E. coli.

7. A composition according to claim 1 wherein the second amylase has at least 80% identity with SEQ ID NO: 2.

8. A composition according to claim 1 wherein the cleaning adjunct comprises a non-soap anionic surfactant or mixture of non-soap anionic surfactants optionally in combination with alkoxylated alkyl sulfate surfactant and mixtures thereof.

9. A composition according to claim 1 wherein the cleaning adjunct comprises a surfactant system comprising non-soap anionic surfactant and nonionic surfactant, the weight ratio of non-soap anionic surfactant to nonionic surfactant being from 100:1 to 1:1.

10. A composition according to claim 1 which in a 1 wt % solution in deionised water provides a pH from 7.5 to less than 9.

11. A composition according to claim 1 wherein the cleaning adjunct comprises a peroxygen source and bleach catalyst and/or bleach activator.

12. A composition according to claim 1 wherein the cleaning adjunct comprises a protease.

13. A method of cleaning a surface, comprising (i) forming an aqueous wash liquor comprising a) a glycogen-debranching enzyme having activity to 1,6-glucosidic linkages, b) a second amylase, having activity to alpha-1,4-glycosidic bonds and exhibiting at least 70% identity with SEQ ID NO:2; c) a cleaning adjunct; and d) water; and ii) contacting a textile surface with the aqueous wash liquor for from 1 to 50 minutes in a washing step; and (iii) optionally rinsing and drying said surface.

14. A method according to claim 13 wherein the surface is contacted with the aqueous wash liquor for from 1 to 40 minutes.

15. A method according to claim 13 wherein the temperature of the aqueous wash liquor is from 5 to 40° C.

16. A method according to claim 13 for complex starch-containing soil removal.
